(19) United States
(12) Patent Application Publication
(10) Pub. No.: US 2026/0196179 A1
(43) Pub. Date: Jul. 9, 2026

(54) DISPLAY DEVICE AND ELECTRONIC APPARATUS INCLUDING THE SAME

(71) Applicant: Samsung Display Co., Ltd., Yongin-Si (KR)

(72) Inventors: Sanghun KIM, Yongin-si (KR); Jooyoung CHUN, Yongin-si (KR); NACKHYEON KEUM, Yongin-si (KR); Jaejoong MIN, Yongin-si (KR); Seungjun SHIN, Yongin-si (KR)

(21) Appl. No.: 19/293,343

(22) Filed: Aug. 7, 2025

(30) Foreign Application Priority Data
Jan. 6, 2025 (KR) 10-2025-0001442

(51) Int. Cl. G09G 3/3266; G09G 3/3233

(52) U.S. Cl. CPC G09G 3/3266; G09G 3/3233; G09G 2300/0819; G09G 2300/0842; G09G 2300/0861; G09G 2310/0286; G09G 2310/0291; G09G 2310/08; G09G 2330/021

(57) ABSTRACT

A display device includes a pixel and a first scan driver providing a first scan signal to the pixel. The first scan driver may include a first inverter which inverts a first clock signal and outputs an inverted first clock signal, a first node controller which controls voltage levels of a first node and a second node to have different levels from each other in response to a first input signal and an output signal of the first inverter, a first output buffer which outputs the first scan signal in response to voltage levels of a third node and a fourth node, and a second inverter which inverts the voltage level of the fourth node and provides an inverted voltage level of the fourth node to the third node. The second node may be connected to the fourth node through the first inverter.

### CROSS-REFERENCE TO RELATED APPLICATIONS

This application claims priority under 35 U.S.C. § 119 to Korean Patent Application No. 10-2025-0001442, filed on Jan. 6, 2025, the entire contents of which are hereby incorporated by reference.

### BACKGROUND

The present disclosure herein relates to a display device and an electronic apparatus including the same.

In general, electronic apparatuses, which provide an image to a user, such as smart phones, digital cameras, laptop computers, navigation systems, and smart televisions, include a display device for displaying an image. The display device generates an image and provides the generated image to a user through a display screen.

The display device includes a plurality of pixels for generating an image, a scan driver applying scan signals to the pixels, a data driver applying data voltages to the pixels, and an emission driver applying emission signals to the pixels. The pixels receive the data voltages in response to the scan signals. The pixels display an image by emitting light with luminance corresponding to the data voltages in response to the emission signals.

### SUMMARY

The present disclosure provides a display device which is capable of rapidly charging scan signals to a target level while reducing power consumption and an electronic apparatus including the same.

According to an embodiment of the inventive concept, a display device includes a pixel and a first scan driver configured to provide a first scan signal to the pixel. The first scan driver includes a first inverter configured to invert a first clock signal and output an inverted first clock signal, a first node controller configured to control voltage levels of a first node and a second node to have different levels from each other in response to a first input signal and an output signal of the first inverter, a first output buffer configured to output the first scan signal in response to voltage levels of a third node and a fourth node, and a second inverter configured to invert the voltage level of the fourth node and provide an inverted voltage level of the fourth node to the third node. The second node is connected to the fourth node through the first inverter.

In an embodiment of the inventive concept, an electronic apparatus includes a display module configured to display an image based on data received from a processor, and the processor electrically connected to the display module, and configured to control an operation of the display module. The display module includes a pixel, and a first scan driver configured to provide a first scan signal to the pixel. The first scan driver includes a first inverter configured to invert a first clock signal and output an inverted first clock signal, a first node controller configured to control voltage levels of a first node and a second node to have different levels from each other in response to a first input signal and an output signal of the first inverter, a first output buffer configured to output the first scan signal in response to voltage levels of a third node and a fourth node, and a second inverter configured to invert the voltage level of the fourth node and provide the inverted voltage level of the fourth node to the third node. The second node is connected to the fourth node through the first inverter.

### BRIEF DESCRIPTION OF THE DRAWINGS

The accompanying drawings are included to provide a further understanding of the inventive concept, and illustrate embodiments of the inventive concept together with the description to explain features of the inventive concept.

FIG. 1 is a block diagram of an electronic apparatus according to an embodiment of the inventive concept.

FIG. 2 shows schematic diagrams of electronic apparatuses according to various embodiments.

FIG. 3 illustrates a cross-section of a display device according to an embodiment of the inventive concept.

FIG. 4 illustrates a cross-section of a display panel illustrated in FIG. 3,

FIG. 5 is a block diagram of a display device according to an embodiment of the inventive concept.

FIG. 6 illustrates an equivalent circuit of a pixel among a plurality of pixels illustrated in FIG. 5.

FIG. 7 is a timing diagram of scan signals and an emission signal for describing an operation of the pixel illustrated in FIG. 6.

FIG. 8 is a block diagram of a first scan driver included in a scan driver illustrated in FIG. 5.

FIG. 9 illustrates a circuit configuration of a first stage of a first scan driver illustrated in FIG. 8.

FIG. 10A is a timing diagram of signals applied to first and second stages of a first scan driver illustrated in FIG. 8.

FIG. 10B is a timing diagram of signals applied to third and fourth stages of a first scan driver illustrated in FIG. 8.

FIGS. 11A, 11B, and 11C illustrate operations of a first stage of a first scan driver with respect to a first period, second period, and third period illustrated in FIG. 10A.

FIG. 12 illustrates a charge state of a first write scan signal which is output through an output terminal illustrated in FIG. 9.

FIG. 13 illustrates a circuit configuration of a first stage of a first scan driver according to an embodiment of the inventive concept.

FIG. 14 is a timing diagram of signals applied to a first stage of a first scan driver illustrated in FIG. 13.

FIGS. 15A and 15B illustrate operations of a first stage of a first scan driver with respect to a first period and second period illustrated in FIG. 14.

FIG. 16 is a block diagram of a second scan driver included in a scan driver illustrated in FIG. 5.

FIG. 17 illustrates a circuit configuration of a first stage of a second scan driver illustrated in FIG. 16.

FIG. 18 is a timing diagram of signals applied to first and second stages of a second scan driver illustrated in FIG. 16.

FIGS. 19A and 19B illustrate operations of a first stage of a second scan driver with respect to a first period and second period illustrated in FIG. 18.

FIG. 20 is a timing diagram of signals applied to first and second stages of a third scan driver.

FIG. 21A illustrates an operation of a first stage of a third scan driver with respect to a second period illustrated in FIG. 20.

FIG. 21B illustrates an operation of a first stage of a third scan driver with respect to a first period illustrated in FIG. 20.

### DETAILED DESCRIPTION

In this specification, it will be understood that when an element (or a region, a layer, a portion, or the like) is referred to as being “on”, “connected to” or “coupled to” another element, it may be directly disposed on, connected to or coupled to the other element, or indirectly on, connected to or coupled to the other element with an intervening element disposed therebetween.

Like reference numerals or symbols refer to like elements throughout this specification. In the drawings, the thickness, ratio, and size of the elements are exaggerated for effectively describing the technical features of the inventive concept. As used herein, the term “and/or” includes any and all combinations of one or more of the associated listed elements.

It will be understood that, although the terms “first”, “second”, etc. may be used herein to describe various elements, the elements are not to be limited by these terms. These terms are only used to distinguish one element, component, region, layer or section from another element, component, region, layer or section. For instance, a first element, component, region, layer or section discussed below could be referred to as a second element, component, region, layer or section without departing from the scope of the inventive concept. Similarly, a second element, component, region, layer or section could also be referred to as a first element, component, region, layer or section. In this specification, the singular expressions “a”, “an” and “the” are intended to include the plural forms as well, unless the context clearly indicates otherwise.

In addition, the terms “below”, “under”, “on the lower side”, “above”, “over”, “on the upper side”, or the like may be used to describe the spatial relation between the elements illustrated in the drawings. These terms have relative concepts and are described on the basis of the directions indicated in the drawings.

It will be further understood that the terms “comprises, includes, has” and/or “comprising, including, having”, when used in this specification, specify the presence of stated features, numbers, steps, operations, elements, components, or combinations thereof, but do not preclude the possibility of the presence or addition of one or more other features, numbers, steps, operations, elements, components, and/or combinations thereof.

Unless defined otherwise, all terms (including technical and scientific terms) used herein have the same meaning as commonly understood by one of ordinary skills in the art to which the inventive concept pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the inventive concept are described with reference to the drawings.

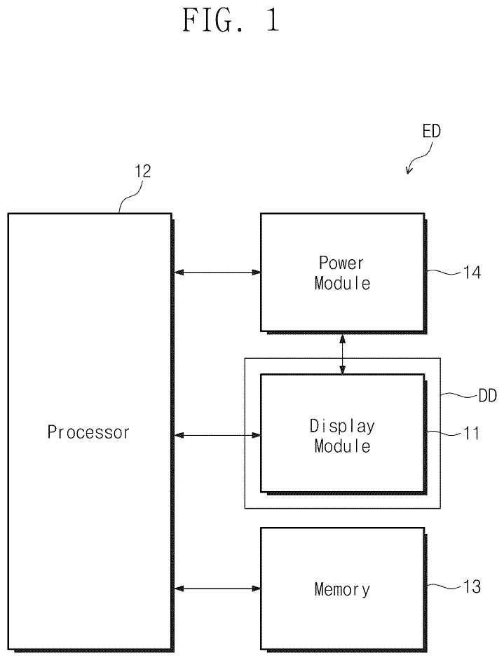

FIG. 1 is a block diagram of an electronic apparatus according to an embodiment of the inventive concept.

Referring to FIG. 1, an electronic apparatus ED according to an embodiment may include a display device DD for providing an image to a user, and may further include a module or device, which has additional functions other than providing the image to the user like the display device DD. For example, the electronic apparatus ED according to an embodiment may include a display module 11 included in the display device DD, a processor 12, a memory 13, and a power module 14.

The processor 12 may include at least one of a central processing unit (CPU), an application processor (AP), a graphic processing unit (GPU), a communication processor (CP), an image signal processor (ISP), or a controller.

The processor 12 may process an image signal and provide the signal to the display device DD. For example, the processor 12 may process an image signal and provide the signal to the display module 11. The processor 12 may be connected to the display device DD through a flexible circuit board, a connector, or the like. The display device DD may display an image based on the signal, e.g., data, received from the processor 12. For example, the display module 11 may display an image based on data received from the processor 12.

In an embodiment, the processor 12 may be divided into two or more blocks, from a functional or structural perspective. For example, the processor 12 may include a main processor in the form of a first driving chip including a central processing unit, and an auxiliary processor in the form of a second driving chip including a controller that receives an image signal from the main processor and processes the image signal to comply with an interface specification of the display module 11.

In the memory 13, data information necessary for an operation of the processor 12 or the display module 11 may be stored. When the processor 12 executes an application stored in the memory 13, an image data signal and/or an input control signal may be transmitted to the display module 11, and the display module 11 may process the received signal and output image information through a display screen.

The power module 14 may include a power supply module such as a power adapter or battery unit, and a power conversion module which converts the power provided from the power supply module and generates power necessary for an operation of the electronic apparatus ED.

At least one of individual components of the aforementioned electronic apparatus ED may be included within the display device DD according to the embodiments described above. In addition, some of the individual modules that are functionally included within one module may be included within the display device DD, while others may be provided separately from the display device DD. For example, while the display device DD may include the display module 11, the processor 12, and the memory 13, the power module 14 may be provided in the form of a separate device from the display device DD but included within the electronic apparatus ED.

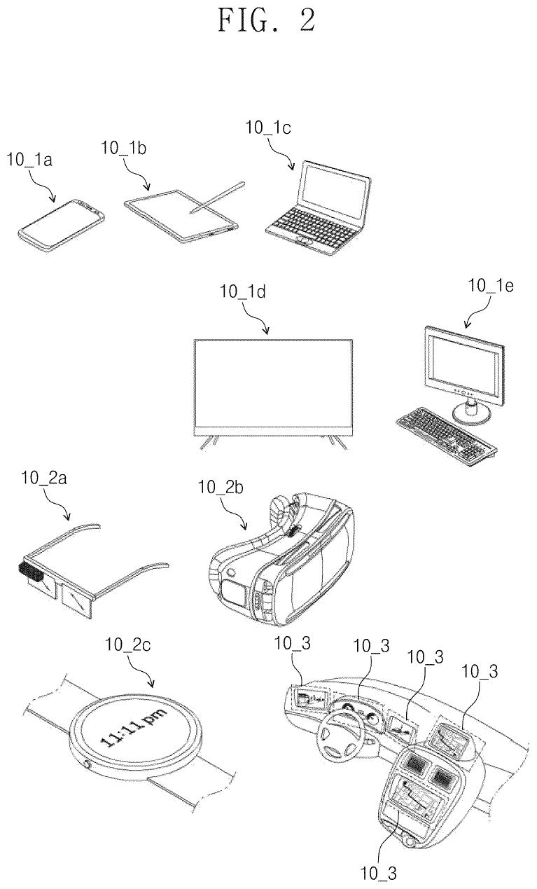

FIG. 2 shows schematic diagrams of electronic apparatuses according to various embodiments.

Referring to FIG. 2, a display device DD according to an embodiment of the inventive concept may be applied to various electronic apparatuses. For example, various electronic apparatuses to which the display device DD according to an embodiment is applied may include electronic apparatuses for displaying an image, such as a smart phone 10_1a, a tablet PC 10_1b, a laptop computer 10_1c, a TV 10_1d, or a monitor for a desk 10_1e.

In addition, various electronic apparatuses to which the display device DD according to an embodiment is applied may include wearable electronic apparatuses, such as smart glasses 10_2a, a head-mounted display 10_2b, or a smart watch 10_2c. In addition, various electronic apparatuses to which the display device DD according to an embodiment is applied may include electronic apparatuses for vehicles 10_3, such as an instrument panel of the vehicle, a center fascia, a central information display (CID) positioned on a dashboard, or a room mirror display.

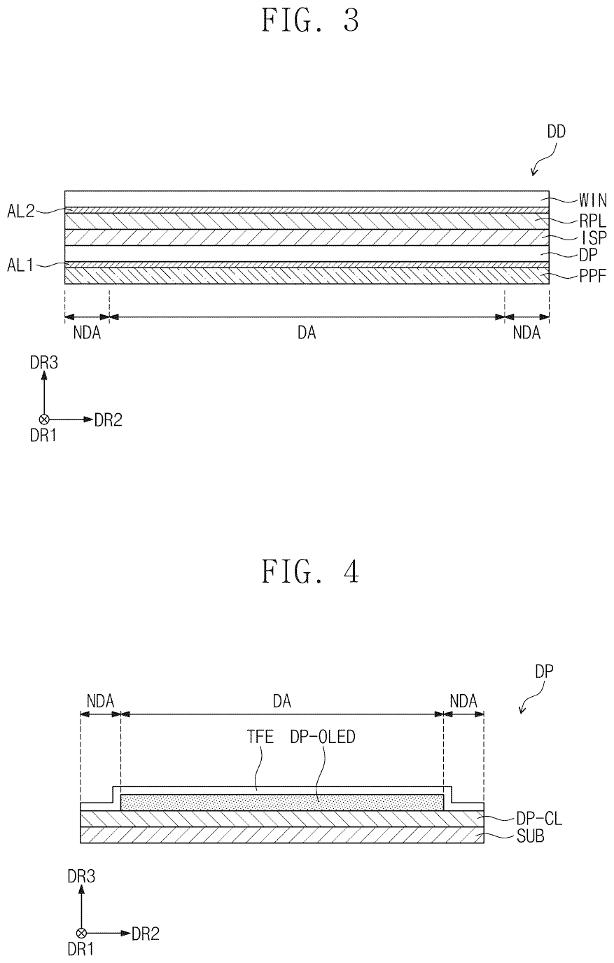

FIG. 3 illustrates a cross-section of a display device according to an embodiment of the inventive concept.

Referring to FIG. 3, a display device DD may include a display panel DP, an input sensing part ISP, an anti-reflection layer RPL, a window WIN, a panel protection film PPF, and first and second adhesive layers AL1 and AL2. The aforementioned display module 11 may include the display panel DP, the input sensing part ISP, the anti-reflection layer RPL, and the panel protection film PPF, as illustrated in FIG. 3.

The display panel DP according to an embodiment of the inventive concept may be an emissive display panel. For example, the display panel DP may be an organic emissive display panel or an inorganic emissive display panel. A light-emitting layer of the organic emissive display panel may include an organic light-emitting material. A light-emitting layer of the inorganic emissive display panel may include quantum dots, quantum rods, or the like. Hereinafter, the display panel DP is described as an organic emissive display panel for the convenience of the description.

The input sensing part ISP may be disposed on the display panel DP. The input sensing part ISP may include a plurality of sensing parts (not illustrated) for sensing an external input in a capacitive manner. The input sensing part ISP may be directly manufactured on the display panel DP during the manufacture of the display device DD. However, an embodiment of the inventive concept is not limited thereto, and the input sensing part ISP may be separately manufactured from the display panel DP, and attached to the display panel DP using an adhesive layer.

The anti-reflection layer RPL may be disposed on the input sensing part ISP. The anti-reflection layer RPL may be directly manufactured on the input sensing part ISP during the manufacture of the display device DD. However, an embodiment of the inventive concept is not limited thereto, and the anti-reflection layer RPL may be separately manufactured, and attached to the input sensing part ISP using an adhesive layer.

The anti-reflection layer RPL may be defined as an anti-reflection film with respect to external light. The anti-reflection layer RPL may reduce the reflectance of the external light incident toward the display panel DP from above the display device DD. Due to the anti-reflection layer RPL, the user may not perceive the external light reflected from the display device DD.

When the external light travelling toward the display panel DP is reflected from the display panel DP and returned back to a user, the user may view perceive the display panel as a mirror due to the reflected external light. To prevent such a phenomenon, for example, the anti-reflection layer RPL may include a plurality of color filters which produces the same colors as those of pixels arranged in the display panel DP.

The color filters may filter the external light to represent the same colors as the pixels. In this case, the external light may be invisible to the user. However, an embodiment of the inventive concept is not limited thereto, and the anti-reflection layer RPL may include a retarder and/or a polarizer so as to reduce the reflectance of the external light.

The window WIN may be disposed on the anti-reflection layer RPL. The window WIN may protect the display panel DP, the input sensing part ISP, and the anti-reflection layer RPL from external impacts and scratches.

The panel protection film PPF may be disposed under the display panel DP. The panel protection film PPF may protect a lower part of the display panel DP. The panel protection film PPF may include a flexible plastic material such as polyethyleneterephthalate (PET).

The first adhesive layer AL1 may be disposed between the display panel DP and the panel protection film PPF, and the display panel DP and the panel protection film PPF may be bonded to each other by the first adhesive layer AL1. The second adhesive layer AL2 may be disposed between the window WIN and the anti-reflection layer RPL, and the window WIN and the anti-reflection layer RPL may be bonded to each other by the second adhesive layer AL2.

FIG. 4 illustrates a cross-section of the display panel illustrated in FIG. 3.

Referring to FIG. 4, the display panel DP may include a substrate SUB, a circuit element layer DP-CL disposed on the substrate SUB, a display element layer DP-OLED disposed on the circuit element layer DP-CL, and a thin-film encapsulation layer TFE disposed on the display element layer DP-OLED.

The substrate SUB may include a display region DA and a non-display region NDA around the display region DA. The substrate SUB may include glass or a flexible plastic material such as polyimide (PI). The display element layer DP-OLED may be positioned in the display region DA.

A plurality of pixels may be disposed in the circuit element layer DP-CL and the display element layer DP-OLED. Each of the pixels may include a transistor disposed in the circuit element layer DP-CL and a light-emitting element disposed in the display element layer DP-OLED and connected to the transistor.

The thin-film encapsulation layer TFE may be disposed on the circuit element layer DP-CL so as to cover the display element layer DP-OLED. The thin-film encapsulation layer TFE may protect the pixels from moisture, oxygen, and external foreign matters.

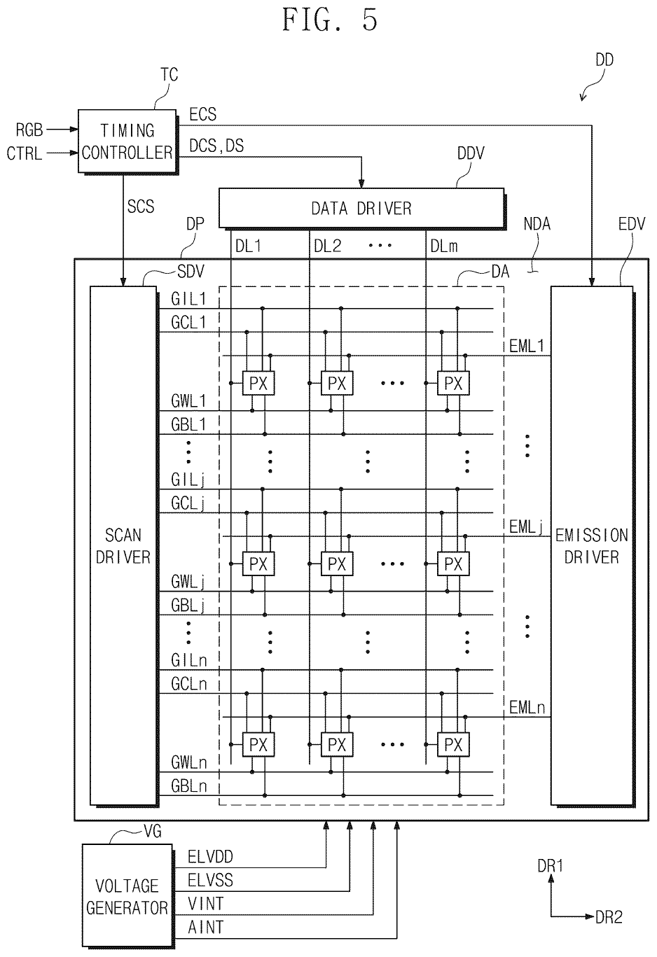

FIG. 5 is a block diagram of a display device according to an embodiment of the inventive concept.

Referring to FIG. 5, a display device DD may include a display panel DP, a timing controller TC, a data driver DDV, a scan driver SDV, an emission driver EDV, and a voltage generator VG.

The display panel DP may include a plurality of scan lines GILI to GILn, GCL1 to GCLn, GWL1 to GWLn, and GBL1 to GBLn, a plurality of emission lines EML1 to EMLn, a plurality of data lines DL1 to DLm, and a plurality of pixels PX. Herein, n and m may represent natural numbers.

A planar region of the display panel DP may include a display region DA and a non-display region NDA surrounding the display region DA. The pixels PX may be disposed in the display region DA. The pixels PX may be electrically connected to the scan lines GILI to GILn, GCL1 to GCLn, GWL1 to GWLn, and GBL1 to GBLn, the emission lines EML1 to EMLn, and the data lines DL1 to DLm.

Each of the pixels PX may be electrically connected to four corresponding scan lines and one corresponding emission line. For example, pixels of a j-th row may be connected to j-th scan lines GILj, GCLj, GWLj, and GBLj, and a j-th emission line EMLj. Herein, j may represent a natural number.

The scan lines GILI to GILn, GCL1 to GCLn, GWL1 to GWLn, and GBL1 to GBLn may include a plurality of initialization scan lines GILI to GILn, a plurality of compensation scan lines GCL1 to GCLn, a plurality of write scan lines GWL1 to GWLn, and a plurality of bias scan lines GBL1 to GBLn.

Each of the pixels PX may be connected to corresponding one of the initialization scan lines GILI to GILn, corresponding one of the compensation scan lines GCL1 to GCLn, corresponding one of the write scan lines GWL1 to GWLn, and corresponding one of the bias scan lines GBL1 to GBLn.

The scan driver SDV may be disposed at a first side of the display panel DP. The scan lines GILI to GILn, GCL1 to GCLn, GWL1 to GWLn, and GBL1 to GBLn may extend in a second direction DR2 from the scan driver SDV.

The emission driver EDV may be disposed at a second side of the display panel DP. The emission lines EML1 to EMLn may extend in a direction opposite to the second direction DR2 from the emission driver EDV. The first side and the second side of the display panel DP may be two opposite sides of the display panel DP in the second direction.

In an embodiment illustrated in FIG. 5, the scan driver SDV and the emission driver EDV may be positioned at two opposite sides with the pixels PX therebetween, but an embodiment of the inventive concept is not limited thereto. For example, the scan driver SDV and the emission driver EDV may be positioned at the same side, for example, at either the first side or the second side of the display panel DP. For example, the scan driver SDV and the emission driver EDV may be implemented as one circuit.

The scan lines GILI to GILn, GCL1 to GCLn, GWL1 to GWLn, and GBL1 to GBLn and the emission lines EML1 to EMLn may be arranged in a first direction DR1. The data lines DL1 to DLm may extend in a direction opposite to the first direction DR1 from the data driver DDV, and may be arranged in the second direction DR2.

The timing controller TC may receive an input image signal RGB and an input control signal CTRL from the processor 12 illustrated in FIG. 1. The timing controller TC may convert a data format of the input image signal RGB to comply with an interface specification of the data driver DDV, and generate an image data signal DS. The timing controller TC may output a scan control signal SCS, a data control signal DCS, and an emission control signal ECS in response to the input control signal CTRL.

The data driver DDV may receive the data control signal DCS and the image data signal DS from the timing controller TC. The data driver DDV may convert the image data signal DS into data signals, and output the data signals. The data signals may be defined as analog voltages corresponding to a gray level of the image data signal DS. The data signals may be applied to the pixels PX through the data lines DL1 to DLm.

The voltage generator VG may generate voltages necessary for an operation of the display panel DP. The voltage generator VG may generate a first drive voltage ELVDD, a second drive voltage ELVSS, a first initialization voltage VINT, and a second initialization voltage AINT. The first drive voltage ELVDD, the second drive voltage ELVSS, the first initialization voltage VINT, and the second initialization voltage AINT may be applied to the pixels PX.

The scan driver SDV may receive the scan control signal SCS from the timing controller TC. The scan driver SDV may output scan signals to the scan lines GILI to GILn, GCL1 to GCLn, GWL1 to GWLn, and GBL1 to GBLn in response to the scan control signal SCS. The scan signals may be applied to the pixels PX through the scan lines GILI to GILn, GCL1 to GCLn, GWL1 to GWLn, and GBL1 to GBLn.

The emission driver EDV may receive the emission control signal ECS from the timing controller TC. The emission driver EDV may output emission signals to the emission lines EML1 to EMLn in response to the emission control signal ECS. The emission signals may be applied to the pixels PX through the emission lines EML1 to EMLn.

The pixels PX may receive data voltages in response to the scan signals. The pixels PX may display an image by emitting light with luminance corresponding to the data voltages in response to the emission signals.

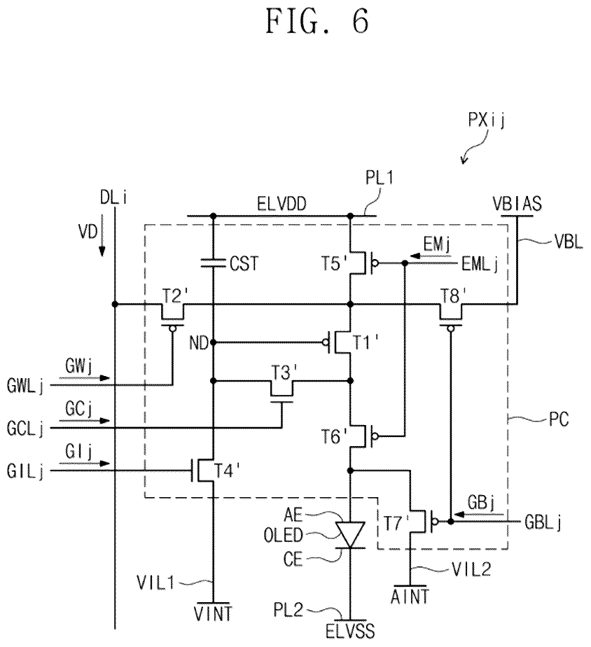

FIG. 6 illustrates an equivalent circuit of a pixel among a plurality of pixels illustrated in FIG. 5.

For example, FIG. 6 illustrates a pixel PXij connected to an i-th data line DLi, j-th scan lines GWLj, GCLj, GILj, and GBLj, and a j-th emission line EMLj. Herein, i may represent a natural number.

Referring to FIG. 6, the pixel PXij may include a pixel circuit PC and a light-emitting element OLED connected to the pixel circuit PC. The pixel circuit PC may drive the light-emitting element OLED.

The pixel circuit PC may include a plurality of transistors T1′ to T8′ and a capacitor CST. The transistors T1′ to T8′ and the capacitor CST may control an amount of current flowing to the light-emitting element OLED. The light-emitting element OLED may generate light with predetermined luminance corresponding to the amount of the current.

A j-th write scan line GWLj may receive a j-th write scan signal GWj, and a j-th compensation scan line GCLj may receive a j-th compensation scan signal GCj. A j-th initialization scan line GILj may receive a j-th initialization scan signal GIj, and a j-th bias scan line GBLj may receive a j-th bias scan signal GBj. The j-th emission line EMLj may receive a j-th emission signal EMj.

The pixel PXij may be connected to the i-th data line DLi, the j-th write scan line GWLj, the j-th compensation scan line GCLj, the j-th initialization scan line GILj, the j-th bias scan line GBLj, the j-th emission line EMLj, a first initialization line VIL1, a second initialization line VIL2, a bias line VBL, and first and second power supply lines PL1 and PL2.

The first initialization line VIL1 may receive a first initialization voltage VINT, and the second initialization line VIL2 may receive a second initialization voltage AINT. The bias line VBL may receive a bias voltage VBIAS. The first power supply line PL1 may receive a first drive voltage ELVDD, and the second power supply line PL2 may receive a second drive voltage ELVSS.

Each of the transistors T1′ to T8′ may include a source electrode, a drain electrode, and a gate electrode. Hereinafter, in FIG. 6, for convenience of explanation, any one of the source electrode or the drain electrode is referred to as a first electrode, and the other one is referred to as a second electrode. In addition, the gate electrode is referred to as a control electrode.

The transistors T1′ to T8′ may include first to eighth transistors T1′ to T8′. The first, second, and fifth to eighth transistors T1′, T2′, and T5′ to T8′ may be PMOS transistors. The third and fourth transistors T3′ and T4′ may be NMOS transistors.

The first transistor T1′ may be referred to as a driving transistor, and the second transistor T2′ may be referred to as a switching transistor. The third transistor T3′ may be referred to as a compensation transistor. The fourth transistor T4′ and the seventh transistor T7′ may be referred to as initialization transistors. The fifth transistor T5′ and the sixth transistor T6′ may be referred to as emission control transistors. The eighth transistor T8′ may be referred to as a bias transistor.

The light-emitting element OLED may be referred to as an organic light-emitting element. The light-emitting element OLED may include an anode AE and a cathode CE. The anode AE may be connected to the first power supply line PL1, which receives the first drive voltage ELVDD, through the sixth, first, and fifth transistors T6′, T1′, and T5′.

The cathode CE may be connected to the second power supply line PL2, which receives the second drive voltage ELVSS having a lower level than the first drive voltage ELVDD.

The first transistor T1′ may be disposed between the fifth transistor T5′ and the sixth transistor T6′ and may be connected to the fifth transistor T5′ and the sixth transistor T6′. The first transistor T1′ may be connected to the first power supply line PL1 through the fifth transistor T5′, and connected to the anode AE through the sixth transistor T6′.

The first transistor T1′ may include a first electrode connected to the first power supply line PL1 through the fifth transistor T5′, a second electrode connected to the anode AE through the sixth transistor T6′, and a control electrode connected to a node ND.

The first electrode of the first transistor T1′ may be connected to the fifth transistor T5′, and the second electrode of the first transistor T1′ may be connected to the sixth transistor T6′. The first transistor T1′ may control an amount of current flowing to the light-emitting element OLED according to a voltage of the node ND, which is applied to the control electrode of the first transistor T1′.

The second transistor T2′ may be disposed between the first transistor T1′ and the i-th data line DLi and may be connected to the first transistor T1′ and the i-th data line DLi. The second transistor T2′ may include a first electrode connected to the i-th data line DLi, a second electrode connected to the first electrode of the first transistor T1′, and a control electrode connected to the j-th write scan line GWLj.

The second transistor T2′ may be turned on in response to the j-th write scan signal GWj applied through the j-th write scan line GWLj, and may electrically connect the i-th data line DLi to the first electrode of the first transistor T1′. The second transistor T2′ may perform a switching operation for providing a data voltage VD (corresponding to the aforementioned data signal) applied through the i-th data line DLi to the first electrode of the first transistor T1′.

The third transistor T3′ may be connected to the second electrode of the first transistor T1′ and the node ND. The third transistor T3′ may include a first electrode connected to the second electrode of the first transistor T1′, a second electrode connected to the node ND, and a control electrode connected to the j-th compensation scan line GCLj.

The third transistor T3′ may be turned on in response to the j-th compensation scan signal GCj applied through the j-th compensation scan line GCLj, and may electrically connect the second electrode of the first transistor T1′ to the control electrode of the first transistor T1′. When the third transistor T3′ is turned on, the first transistor T1′ and the third transistor T3′ may be connected in a diode form.

The fourth transistor T4′ may be connected to the node ND. The fourth transistor T4′ may include a first electrode connected to the node ND, a second electrode connected to the first initialization line VIL1, and a control electrode connected to the j-th initialization scan line GILj. The fourth transistor T4′ may be turned on in response to the j-th initialization scan signal GIj applied through the j-th initialization scan line GILj, and may provide the first initialization voltage VINT applied through the first initialization line VIL1 to the node ND.

The fifth transistor T5′ may include a first electrode connected to the first power supply line PL1, a second electrode connected to the first electrode of the first transistor T1′, and a control electrode connected to the j-th emission line EMLj.

The sixth transistor T6′ may include a first electrode connected to the second electrode of the first transistor T1′, a second electrode connected to the anode AE, and a control electrode connected to the j-th emission line EMLj.

The fifth transistor T5′ and the sixth transistor T6′ may be turned on in response to the j-th emission signal EMj applied through the j-th emission line EMLj. The first drive voltage ELVDD may be provided to the light-emitting element OLED through the fifth transistor T5′ and the sixth transistor T6′ which are turned on, and thus drive current may flow to the light-emitting element OLED. Accordingly, the light-emitting element OLED may emit light.

The seventh transistor T7′ may include a first electrode connected to the anode AE, a second electrode connected to the second initialization line VIL2, and a control electrode connected to the j-th bias scan line GBLj. The seventh transistor T7′ may be turned on in response to the j-th bias scan signal GBj applied through the j-th bias scan line GBLj, and may provide the second initialization voltage AINT received through the second initialization line VIL2 to the anode AE of the light-emitting element OLED.

Although a pixel PXij in FIG. 6 includes the seventh transistor T7′, the inventive concept is not limited thereto. For example, the seventh transistor T7′ may be omitted. In an embodiment of the inventive concept, the second initialization voltage AINT may have a different level from the first initialization voltage VINT, but is not limited thereto and may have the same level as the first initialization voltage VINT.

The seventh transistor T7′ may improve black expression capability of the pixel PXij. When the seventh transistor T7′ is turned on, a parasitic capacitor (not illustrated) of the light-emitting element OLED may be discharged. Accordingly, when implementing black luminance, the light-emitting element OLED may not emit light due to a leakage current of the first transistor T1′, thereby improving the black expression capability.

The capacitor CST may include a first electrode connected to the first power supply line PL1 and a second electrode connected to the node ND. When the fifth transistor T5′ and the sixth transistor T6′ are turned on, an amount of current flowing to the first transistor T1′ may be determined depending on the voltage stored in the capacitor CST.

The eighth transistor T8′ may include a first electrode connected to the bias line VBL, a second electrode connected to the first electrode of the first transistor T1′, and a control electrode connected to the j-th bias scan line GBLj.

The eighth transistor T8′ may be turned on in response to the j-th bias scan signal GBj, and may provide the bias voltage VBIAS to the first electrode of the first transistor T1′.

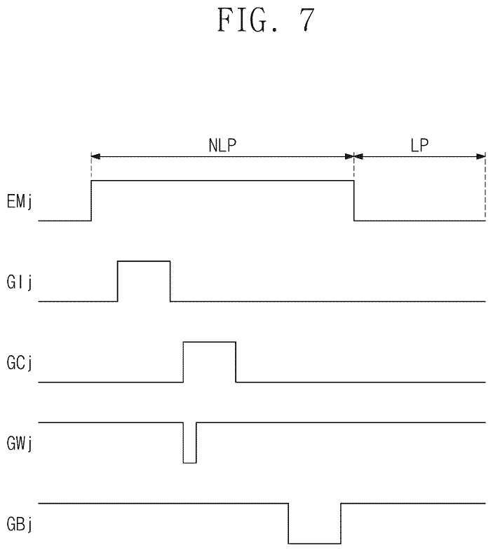

FIG. 7 is a timing diagram of scan signals and an emission signal for describing an operation of the pixel illustrated in FIG. 6.

Referring to FIGS. 6 and 7, a j-th emission signal EMj may have a high level during a non-emission period NLP, and may have a low level during an emission period LP. A period when each of the j-th write scan signal GWj and the j-th bias scan signal GBj has a low level may be referred to as an activation period of each of a j-th write scan signal GWj and a j-th bias scan signal GBj. A period when each the j-th compensation scan signal GCj and the j-th initialization scan signal GIj has a high level may be referred to as an activation period of each of a j-th compensation scan signal GCj and a j-th initialization scan signal GIj.

After the j-th initialization scan signal GIj is activated, the j-th compensation scan signal GCj and the j-th write scan signal GWj may be activated. Then, the j-th bias scan signal GBj may be activated.

During the non-emission period NLP, the j-th initialization scan signal GIj in an active state, the j-th compensation scan signal GCj in an active state, the j-th write scan signal GWj in an active state, and the j-th bias scan signal GBj in an active state may be applied to the pixel PXij.

When the j-th initialization scan signal GIj is in an activation period, the j-th initialization scan signal GIj having a high level may be applied to the fourth transistor T4′ and the fourth transistor T4′ may be turned on. The first initialization voltage VINT may be provided to the node ND through the fourth transistor T4′. Accordingly, the first initialization voltage VINT may be applied to the control electrode of the first transistor T1′, and the first transistor T1′ may be initialized by the first initialization voltage VINT. Such an operation may be referred to as an initialization operation.

When the j-th write scan signal GWj is in an activation period, the j-th write scan signal GWj having a low level may be applied to the second transistor T2′, and the second transistor T2′ may be turned on. In addition, when the j-th compensation scan signal GCj is in an activation period, the j-th compensation scan signal GCj having a high level may be applied to the third transistor T3′, and the third transistor T3′ may be turned on.

The first transistor T1′ and the third transistor T3′ may be connected to each other in a form of a diode. In this case, a compensation voltage Vd-Vth, which is reduced by a threshold voltage Vth of the first transistor T1′ from the data voltage VD provided through the data line DLi, may be applied to the control electrode of the first transistor T1′. Such an operation may be referred to as a write operation (or programming operation) and a compensation operation.

The first voltage ELVDD and the compensation voltage Vd-Vth may be respectively applied to the first electrode and the second electrode of the capacitor CST. In the capacitor CST, a charge corresponding to a difference between a voltage of the first electrode of the capacitor CST and a voltage of the second electrode of the capacitor CST may be stored.

Afterwards, when the j-th bias scan signal GBj is in an activation period, the j-th bias scan signal GBj having a low level may be applied to the seventh and eighth transistors T7′ and T8′, and the seventh and eighth transistors T7′ and T8′ may be turned on. The second initialization voltage AINT may be provided to the anode AE through the seventh transistor T7′, and the anode AE may be initialized to the second initialization voltage AINT. The bias voltage VBIAS may be applied to the first electrode of the first transistor T1′ through the eighth transistor T8′.

Thereafter, during the emission period LP, the j-th emission signal EMj having a low level may be applied to the fifth transistor T5′ and the sixth transistor T6′ through the j-th emission line EMLj, and thus the fifth transistor T5′ and the sixth transistor T6′ may be turned on. In this case, the drive current Id corresponding to a voltage difference between the first voltage ELVDD and a voltage of the control electrode of the first transistor T1′ may be generated. The drive current Id may be provided to the light-emitting element OLED through the sixth transistor T6′, and thus the light-emitting element OLED may emit light.

During the emission period LP, a gate-source voltage Vgs of the first transistor T1′ may be maintained by the capacitor CST and the gate-source voltage Vgs of the first transistor T1′ may be expressed as Vgs=ELVDD−(Vd−Vth). A relational expression of current and voltage of the first transistor T1′ may be defined as Id=(½)μCox (W/L) (Vgs−Vth)². Such an expression is the relational expression of current and voltage of a general transistor.

When Vgs is substituted into the relational expression of current and voltage, the threshold voltage Vth is removed, and the drive current Id may be proportional to the square of the value obtained by subtracting the data voltage VD from the first drive voltage ELVDD, i.e., (ELVDD-Vd)². Accordingly, the drive current Id may be determined regardless of the threshold voltage Vth of the first transistor T1′. Such an operation may be referred to as a threshold voltage compensation operation.

The bias voltage VBIAS may be applied to the first electrode of the first transistor T1′ through the eighth transistor T8′ after the threshold voltage of the first transistor T1′ is compensated and before the light-emitting element OLED emits light. A shift of a hysteresis curve of the first transistor T1′ may be reduced by the bias voltage VBIAS. Such an operation may be referred to as a bias operation.

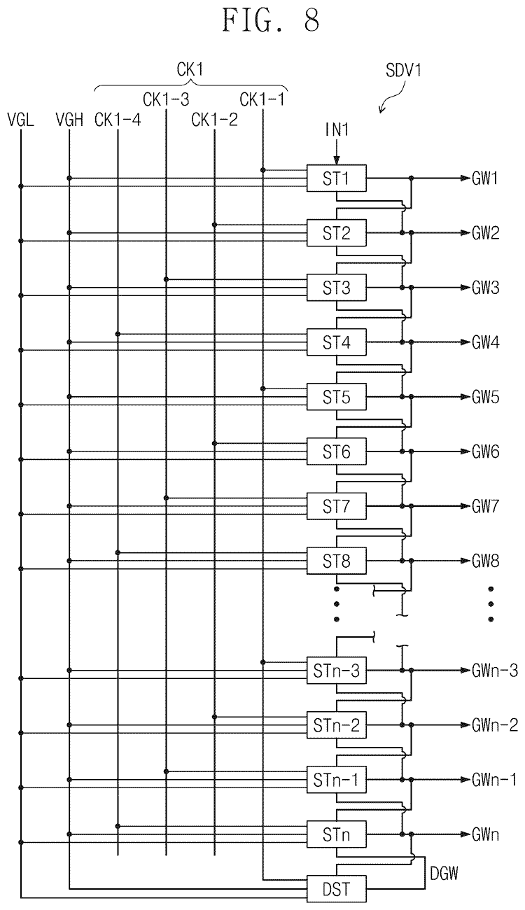

FIG. 8 is a block diagram of a first scan driver included in the scan driver illustrated in FIG. 5.

Referring to FIGS. 5 and 8, the scan driver SDV may include a first scan driver SDV1. The first scan driver SDV1 may include a plurality of stages ST1 to STn connected sequentially and successively. The stages ST1 to STn may include first to n-th stages ST1 to STn.

The stages ST1 to STn of the first scan driver SDV1 may generate and output write scan signals GW1 to GWn. The write scan signals GW1 to GWn may be output through the write scan lines GWL1 to GWLn illustrated in FIG. 5 and provided to the pixels PX.

The stages ST1 to STn of the first scan driver SDV1 may receive a first input signal IN1, a plurality of first clock signals CK1, a first voltage VGH, and a second voltage VGL. The aforementioned scan control signal SCS may include the first input signal IN1 and the first clock signals CK1. The first voltage VGH and the second voltage VGL may be generated in the voltage generator VG illustrated in FIG. 5 and provided to the first scan driver SDV1. The second voltage VGL may have a lower level than the first voltage VGH.

The first clock signals CK1 may include a (1-1)-th clock signal CK1-1, a (1-2)-th clock signal CK1-2, a (1-3)-th clock signal CK1-3, and a (1-4)-th clock signal CK1-4. The (1-1)-th clock signal CK1-1, the (1-2)-th clock signal CK1-2, the (1-3)-th clock signal CK1-3, and the (1-4)-th clock signal CK1-4 may be sequentially shifted clock signals.

The (1-1)-th clock signal CK1-1 may be applied to (4 h-3)-th stages. Herein, h may represent a natural number. The (1-2)-th clock signal CK1-2 may be applied to (4 h-2)-th stages. The (1-3)-th clock signal CK1-3 may be applied to (4h-1)-th stages. The (1-4)-th clock signal CK1-4 may be applied to 4 h-th stages.

For example, the (1-1)-th clock signal CK1-1 may be applied to first, fifth, . . . , and (n−3)-th stages ST1, ST5, . . . , and STn−3. The (1-2)-th clock signal CK1-2 may be applied to second, sixth, . . . , and (n−2)-th stages ST2, ST6, . . . , and STn−2. The (1-3)-th clock signal CK1-3 may be applied to third, seventh, . . . , and (n−1)-th stages ST3, ST7, . . . , and STn−1. The (1-4)-th clock signal CK1-4 may be applied to fourth, eighth, . . . , and n-th stages ST4, ST8, . . . , and STn.

The first input signal IN1 may be applied to the first stage ST1. A (h+1)-th stage may receive a write scan signal output from a h-th stage. For example, as illustrated in FIG. 8, the second stage ST2 may receive a first write scan signal GW1 output from the first stage ST1. Hereinafter, the write scan signal, which is output from the h-th stage and input to the (h+1)-th stage, may be referred to as a first input signal, like the first input signal IN1 applied to the first stage ST1.

The h-th stage may receive a write scan signal output from the (h+1)-th stage. For example, the first stage ST1 may receive a second write scan signal GW2 output from the second stage ST2.

The first scan driver SDV1 may further include a dummy stage DST arranged after the n-th stage STn and connected the n-th stage STn. The dummy stage DST may receive the (1-1)-th clock signal CK1-1, an n-th write scan signal GWn output from the n-th stage STn, and the first and second voltages VGH and VGL.

The first stage ST1 may be activated by the first input signal IN1. The (h+1)-th stage may be activated by receiving the write scan signal output from the h-th stage. For example, the second stage ST2 may be activated by receiving the first write scan signal GW1 output from the first stage ST1.

The activated stages ST1 to STn may generate the write scan signals GW1 to GWn by using the first clock signals CK1-1 to CK1-4, the first voltage VGH, and the second voltage VGL. The activated stages ST1 to STn may apply the write scan signals GW1 to GWn to the pixels PX. For instance, the write scan signals GW1 to GWn output from the stages ST1 to STn of the first scan driver SDV1 may be referred to as first scan signals.

The dummy stage DST may be activated by receiving the n-th write scan signal GWn output from the n-th stage STn. The dummy stage DST may generate a dummy write scan signal DGW by using the (1-1)-th clock signal CK1-1, the first voltage VGH, and the second voltage VGL. The dummy write scan signal DGW may not be applied to the pixels PX.

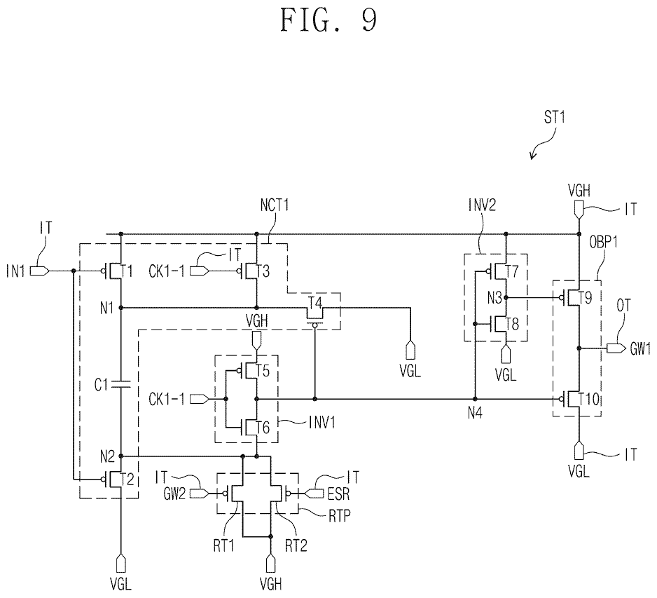

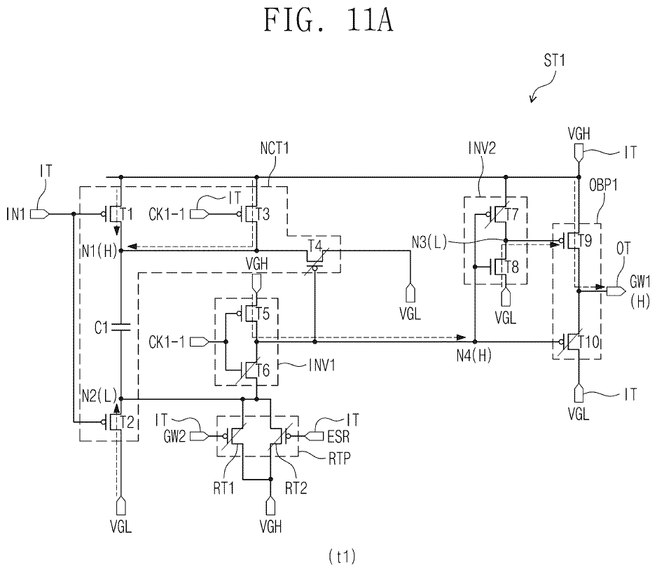

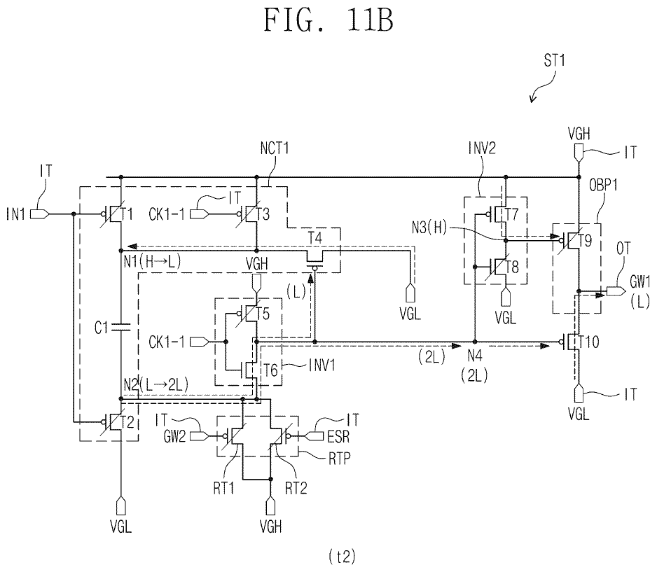

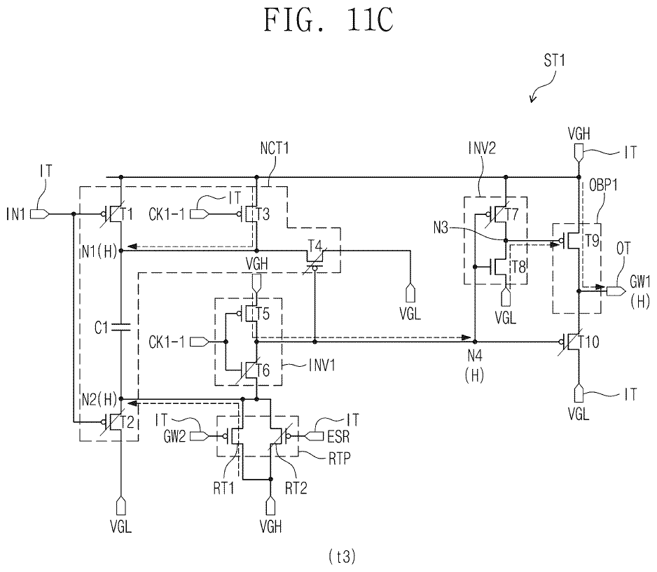

The h-th stage may receive the write scan signal output from the (h+1)-th stage, and initialize a fourth node N4 (illustrated in FIG. 9 below) within the h-th stage using the write signal output from the (h+1)-th stage. For example, the first stage ST1 may receive the second write scan signal GW2 output from the second stage ST2, and initialize a fourth node N4 of the first stage ST1 using the second write scan signal GW2. An initialization operation for the fourth node N4 will be described in detail later with reference to FIG. 11C.

The n-th stage STn may receive the dummy write scan signal DGW output from the dummy stage DST, and initialize a fourth node of the n-th stage STn.

FIG. 9 illustrates a circuit configuration of the first stage of the first scan driver illustrated in FIG. 8.

Although not illustrated, the second to n-th stages ST2 to STn and the dummy stage DST may also have the same circuit configuration as the first stage ST1.

Referring to FIG. 9, the first stage ST1 of the first scan driver SDV1 may receive a first input signal IN1, a (1-1)-th clock signal CK1-1, a first voltage VGH, a second voltage VGL, and a second write scan signal GW2 through input terminals IT. The first stage ST1 may output a first write scan signal GW1 through an output terminal OT.

The first stage ST1 may include a first node controller NCT1, a first inverter INV1, a second inverter INV2, and a first output buffer OBP1. The first inverter INV1 and the second inverter INV2 may invert a phase or a voltage level of an input signal and out the inverted input signal.

The first inverter INV1 may be connected to the first node controller NCT1. The first inverter INV1 may receive the first voltage VGH and the (1-1)-th clock signal CK1-1. The first inverter INV1 may invert the (1-1)-th clock signal CK1-1 and output the inverted (1-1)-th clock signal.

The first node controller NCT1 may be connected to a first node N1 and a second node N2. The first node controller NCT1 may receive the first input signal IN1, the first voltage VGH, the second voltage VGL, and the (1-1)-th clock signal CK1-1. In addition, the first node controller NCT1 may receive an output signal of the first inverter INV1.

The first node controller NCT1 may control a voltage level of the first node N1 and a voltage level of the second node N2 in response to the first input signal IN1, the first voltage VGH, the second voltage VGL, the (1-1)-th clock signal CK1-1, and the output signal of the first inverter INV1. The first node controller NCT1 may control the voltage level of the first node N1 and the voltage level of the second node N2 to have different levels from each other.

The first output buffer OBP1 may be connected to a third node N3 and a fourth node N4. The first output buffer OBP1 may receive the first voltage VGH and the second voltage VGL. The first output buffer OBP1 may output the first write scan signal GW1 depending on a voltage level of the third node N3 and a voltage level of the fourth node N4.

The second inverter INV2 may be connected to the third node N3 and the fourth node N4. The second inverter INV2 may receive the first voltage VGH. The second inverter INV2 may invert the voltage level of the fourth node N4 and provide the inverted voltage level to the third node N3.

The first inverter INV1 may be connected to the second node N2 and the fourth node N4. Accordingly, the second node N2 may be connected to the fourth node N4 through the first inverter INV1. The voltage of the second node N2 may be applied to the fourth node N4 through the first inverter INV1.

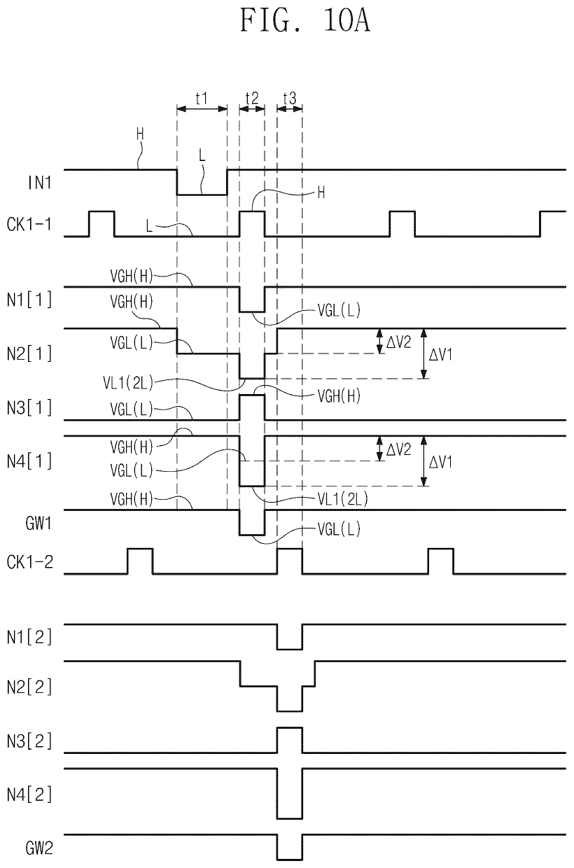

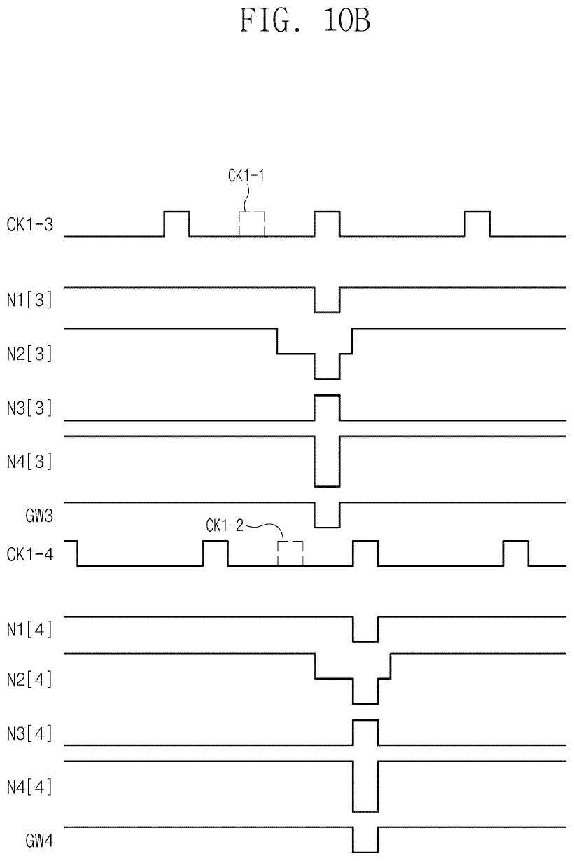

Specific operations of the first node controller NCT1, the first inverter INV1, the second inverter INV2, and the first output buffer OBP1 will be described in detail later with reference to a timing diagram illustrated in FIG. 10A and operation states in each period of a first stage ST1 illustrated in FIGS. 11A to 11C.

Hereinafter, similar to FIG. 6, in each of transistors T1 to T10, RT1, and RT2 illustrated in FIG. 9, any one of a source electrode or a drain electrode is referred to as a first electrode, and the other one is referred to as a second electrode. A gate electrode is defined as a control electrode.

The first node controller NCT1 may include a first transistor T1, a second transistor T2, a third transistor T3, a fourth transistor T4, and a first capacitor C1. The first, second, third, and fourth transistors T1, T2, T3, and T4 may include a PMOS transistor.

The first transistor T1 may include a first electrode receiving the first voltage VGH, a second electrode connected to the first node N1, and a control electrode receiving the first input signal IN1. The first transistor T1 may be turned on or turned off in response to the first input signal IN1.

The second transistor T2 may include a first electrode connected to the second node N2, a second electrode receiving the second voltage VGL, and a control electrode receiving the first input signal IN1. The second transistor T2 may be turned on or turned off in response to the first input signal IN1.

The third transistor T3 may include a first electrode receiving the first voltage VGH, a second electrode connected to the first node N1, and a control electrode receiving the (1-1)-th clock signal CK1-1. The third transistor T3 may be turned on or turned off in response to the (1-1)-th clock signal CK1-1.

The fourth transistor T4 may include a first electrode connected to the first node N1, a second electrode receiving the second voltage VGL, and a control electrode connected to the fourth node N4. The fourth transistor T4 may be turned on or turned off in response to a voltage of the fourth node N4.

The first capacitor C1 may include a first electrode connected to the first node N1 and a second electrode connected to the second node N2.

The first inverter INV1 may include a fifth transistor T5 and a sixth transistor T6. The fifth transistor T5 may include a PMOS transistor, and the sixth transistor T6 may include an NMOS transistor.

The fifth transistor T5 may include a first electrode receiving the first voltage VGH, a second electrode connected to the fourth node N4, and a control electrode receiving the (1-1)-th clock signal CK1-1. The fifth transistor T5 may be turned on or turned off in response to the (1-1)-th clock signal CK1-1.

The sixth transistor T6 may include a first electrode connected to the second node N2, a second electrode connected to the fourth node N4, and a control electrode receiving the (1-1)-th clock signal CK1-1. The sixth transistor T6 may be turned on or turned off in response to the (1-1)-th clock signal CK1-1.

The second inverter INV2 may include a seventh transistor T7 and an eighth transistor T8. The seventh transistor T7 may include a PMOS transistor, and the eighth transistor T8 may include an NMOS transistor.

The seventh transistor T7 may include a first electrode receiving the first voltage VGH, a second electrode connected to the third node N3, and a control electrode connected to the fourth node N4. The seventh transistor T7 may be turned on or turned off in response to the voltage of the fourth node N4.

The eighth transistor T8 may include a first electrode receiving the second voltage VGL, a second electrode connected to the third node N3, and a control electrode connected to the fourth node N4. The eighth transistor T8 may be turned on or turned off in response to the voltage of the fourth node N4.

The first output buffer OBP1 may include a ninth transistor T9 and a tenth transistor T10. The ninth and tenth transistors T9 and T10 may include a PMOS transistor.

The ninth transistor T9 may include a first electrode receiving the first voltage VGH, a second electrode connected to the output terminal OT which outputs the first write scan signal GW1, and a control electrode connected to the third node N3. The ninth transistor T9 may be turned on or turned off in response to a voltage of the third node N3.

The tenth transistor T10 may include a first electrode connected to the output terminal OT, a second electrode receiving the second voltage VGL, and a control electrode connected to the fourth node N4. The tenth transistor T10 may be turned on or turned off in response to the voltage of the fourth node N4.

The first stage ST1 may further include a reset part RTP connected to the second node N2. The first stage ST1 may further receive a reset signal ESR through the input terminal IT. The reset signal ESR may be applied to the reset part RTP. For example, the reset signal ESR is omitted in FIG. 8. The reset signal ESR may be a signal which is activated in a low level when a display device DD is powered on or reset.

The reset part RTP may include a first reset transistor RT1 and a second reset transistor RT2. The first and second reset transistors RT1 and RT2 may include a PMOS transistor.

The first reset transistor RT1 may include a first electrode connected to the second node N2, a second electrode receiving the first voltage VGH, and a control electrode receiving the second write scan signal GW2. The first reset transistor RT1 may be turned on or turned off in response to the second write scan signal GW2. The second write scan signal GW2 applied to the first stage ST1 may be a shifted signal of the first write scan signal GW1, and may be referred to as a first reset signal.

The second reset transistor RT2 may include a first electrode connected to the second node N2, a second electrode receiving the first voltage VGH, and a control electrode receiving the reset signal ESR. The second reset transistor RT2 may be turned on or turned off in response to the reset signal ESR. When the second write scan signal GW2 is called the first reset signal, the reset signal ESR may be referred to as a second reset signal.

FIG. 10A is a timing diagram of signals applied to first and second stages of the first scan driver illustrated in FIG. 8. FIG. 10B is a timing diagram of signals applied to third and fourth stages of the first scan driver illustrated in FIG. 8.

In FIGS. 10A and 10B, the number written in parentheses [ ] indicates an order of stages.

Referring to FIGS. 10A and 10B, a (1-1)-th clock signal CK1-1, a (1-2)-th clock signal CK1-2, a (1-3)-th clock signal CK1-3, and a (1-4)-th clock signal CK1-4 may be sequentially shifted clock signals.

For example, in FIG. 10B, to compare the timing of the (1-3)-th and (1-4)-th clock signals CK1-3 and CK1-4 with the timing of the (1-1)-th and (1-2)-th clock signals CK1-1 and CK1-2, one pulse of each of the (1-1)-th and (1-2)-th clock signals CK1-1 and CK1-2 is drawn in a dotted line at a time point prior to any one pulse of each of the (1-3)-th and (1-4)-th clock signals CK1-3 and CK1-4.

A low level L may have a lower level than a high level H. A first voltage VGH may be defined as a voltage having the high level H, and a second voltage VGL may be defined as a voltage having the low level L. When first to fourth write scan signals GW1 to GW4 are activated, the first to fourth write scan signals GW1 to GW4 may have the low level L, which may correspond to the voltage level of the second voltage VGL.

When the (1-1)-th clock signal CK1-1 of the high level H is applied to the first stage ST1 which was activated in response to a first input signal IN1 of the low level L, the first write scan signal GW1 having the second voltage VGL may be output.

When the (1-2)-th clock signal CK1-2 of the high level H is applied to the second stage ST2 which was activated in response to the first write scan signal GW1 of the low level L, the second write scan signal GW2 having the second voltage VGL may be output.

When the (1-3)-th clock signal CK1-3 of the high level H is applied to the third stage ST3 which was activated in response to the second write scan signal GW2 of the low level L, the third write scan signal GW3 having the second voltage VGL may be output.

When the (1-4)-th clock signal CK1-4 of the high level H is applied to the fourth stage ST4 which was activated in response to the third write scan signal GW3 of the low level L, the fourth write scan signal GW4 having the second voltage VGL may be output.

Since operations of the stages ST1 to STn are substantially the same, hereinafter, the operation of the first stage ST1 will be described with reference to the signals applied to the first stage ST1 with reference to the timing diagram illustrated in FIG. 10A.

FIGS. 11A, 11B, and 11C illustrate operations of a first stage of a first scan driver with respect to a first period, second period, and third period illustrated in FIG. 10A.

Hereinafter, in FIGS. 11A to 11C, transistors that are turned off are indicated by a diagonal line.

Referring to FIGS. 10A and 11A, in a first period t1, the first input signal IN1 having the low level L may be applied to the first stage ST1. First and second transistors T1 and T2 may be turned on in response to the first input signal IN1 having the low level L.

In the first period t1, the (1-1)-th clock signal CK1-1 having the low level may be applied to third, fifth, and sixth transistors T3, T5, and T6. The third and fifth transistors T3 and T5 may be turned on in response to the (1-1)-th clock signal CK1-1 having the low level L, and the sixth transistor T6 may be turned off in response to the (1-1)-th clock signal CK1-1 having the low level L.

The first voltage VGH may be applied to a first node N1 through the turned-on first transistor T1 and the turned-on third transistor T3, and thus the first node N1 may be set to the first voltage VGH. The second voltage VGL may be applied to a second node N2 through the turned-on second transistor T2, and thus the second node N2 may be set to the second voltage VGL. A first capacitor C1 connected between the first node N1 and the second node N2 may store a charge corresponding to a difference between the first voltage VGH and the second voltage VGL.

The first voltage VGH may be applied to a fourth node N4 through the turned-on fifth transistor T5, and thus the fourth node N4 may be set to the first voltage VGH. Since the fourth node N4 has the first voltage VGH, the first voltage VGH of the fourth node N4 may be applied to a fourth transistor T4 and the fourth transistor T4 may be turned off.

Through the above operation, in the first period t1, a first inverter INV1 may output the first voltage VGH in response to the (1-1)-th clock signal CK1-1. The first inverter INV1 may invert the (1-1)-th clock signal CK1-1 having the low level L and output the first voltage VGH having the high level H. The first inverter INV1 may provide the first voltage VGH to a first node controller NCT1 and the fourth node N4.

In addition, when the first inverter INV1 outputs the first voltage VGH in response to the (1-1)-th clock signal CK1-1, the first node controller NCT1 may set the voltage of the first node N1 to the first voltage VGH and set the voltage of the second node N2 to the second voltage VGL, in response to the first input signal IN1. That is, the first node controller NCT1 may control the voltage of the first node N1 and the voltage of the second node N2 to have different levels from each other.

The first voltage VGH of the fourth node N4 may be applied to seventh and eighth transistors T7 and T8. In response to the first voltage VGH of the fourth node N4, the seventh transistor T7 may be turned off, and the eighth transistor T8 may be turned on. The second voltage VGL may be applied to a third node N3 through the turned-on eighth transistor T8, and thus the third node N3 may be set to the second voltage VGL.

Through the above operation, a second inverter INV2 may invert the first voltage VGH having the high level H and output the second voltage VGL having the low level L. The second inverter INV2 may provide the second voltage VGL to the third node N3.

The second voltage VGL of the third node N3 may be applied to a ninth transistor T9, and the first voltage VGH of the fourth node N4 may be applied to a tenth transistor T10. The ninth transistor T9 may be turned on in response to the second voltage VGL of the third node N3, and the tenth transistor T10 may be turned off in response to the first voltage VGH of the fourth node N4. The first voltage VGH may be provided to an output terminal OT through the turned-on ninth transistor T9. Accordingly, through the output terminal OT, the first write scan signal GW1 having the high level H may be output.

Through the above operation, a first output buffer OBP1 may output the first write scan signal GW1 having the high level H in response to the voltages of the third node N3 and the fourth node N4.

Referring to FIGS. 10A and 11B, in a second period t2 after the first period t1, the first input signal IN1 having the high level H and the (1-1)-th clock signal CK1-1 having the high level H may be applied to the first stage ST1.

The first and second transistors T1 and T2 may be turned off in response to the first input signal IN1 having the high level H. The third and fifth transistors T3 and T5 may be turned off, and the sixth transistor T6 may be turned on, in response to the (1-1)-th clock signal CK1-1 having the high level H.

The second voltage VGL of the second node N2 may be applied to the fourth transistor T4 through the turned-on sixth transistor T6. The fourth transistor T4 may be turned on in response to the second voltage VGL of the second node N 2 which has the low level L. The second voltage VGL may be applied to the first node N1 through the turned-on fourth transistor T4. Accordingly, the first node N1 may be set to the second voltage VGL. The voltage of the first node N1 may be converted from the first voltage VGH having the high level H to the second voltage VGL having the low level L.

When the first node N1 is converted from the high level H to the low level L, by a coupling operation of the first capacitor C1, the voltage of the second node N2 may be converted from the second voltage VGL to a third voltage VL1 having a lower level than the second voltage VGL. That is, the voltage of the second node N2 may be changed from the second voltage VGL to the third voltage VL1 by the first capacitor C1. Accordingly, the second node N2 may be set to the third voltage VL1.

For example, the third voltage VL1 may have a low level 2L that is lower than the low level L. A voltage difference AV1 between the first voltage VGH and the third voltage VL1 may be twice a second voltage difference AV2 between the first voltage VGH and the second voltage VGL.

The third voltage VL1 of the second node N2 may be provided to the fourth node N4 through the turned-on sixth transistor T6. That is, the third voltage VL1 of the second node N2 may be provided to the fourth node N4 through the first inverter INV1.

Through the above operation, in the second period t2, the first inverter INV1 may output the voltage of the second node N2 in response to the (1-1)-th clock signal CK1-1. The first inverter INV1 may provide the voltage (for example, the second voltage VGL and the third voltage VL1) of the second node N2 to the first node controller NCT1 and the fourth node N4.

In addition, when the first inverter INV1 outputs the second voltage VGL of the second node N2 according to the (1-1)-th clock signal CK1-1, the first node controller NCT1 may set the voltage of the first node N1 to the second voltage VGL, and set the voltage of the second node N2 to the third voltage VL1, in response to the output signal of the first inverter INV1. That is, the first node controller NCT1 may control the voltage of the first node N1 and the voltage of the second node N2 to have different levels from each other.

Accordingly, in the first period t1 and the second period t2, the first node controller NCT1 may set the voltage of the first node N1 to the first voltage VGH or the second voltage VGL, and set the voltage of the second node N2 to the second voltage VGL or the third voltage VL1, in response to the first input signal IN1 and the output signal of the first inverter INV1.

The third voltage VL1 of the fourth node N4 may be applied to the seventh and eighth transistors T7 and T8. In response to the third voltage VL1 of the fourth node N4, the seventh transistor T7 may be turned on, and the eighth transistor T8 may be turned off. The first voltage VGH may be applied to the third node N3 through the turned-on seventh transistor T7, and thus the third node N3 may be set to the first voltage VGH.

The first voltage VGH of the third node N3 may be applied to the ninth transistor T9, and the third voltage VL1 of the fourth node N4 may be applied to the tenth transistor T10. The ninth transistor T9 may be turned off in response to the first voltage VGH of the third node N3, and the tenth transistor T10 may be turned on in response to the third voltage VL1 of the fourth node N4. The second voltage VGL may be provided to the output terminal OT through the turned-on tenth transistor T10. Accordingly, through the output terminal OT, the first write scan signal GW1 having the low level L may be output.

Through the above operation, during the second period t2, the first output buffer OBP1 may output the activated first write scan signal GW1 having the low level L in response to the voltages of the third node N3 and the fourth node N4.

First and second reset transistors RT1 and RT2 may remain turned-off during the first period t1 and the second period t2.

Referring to FIGS. 10A and 11C, in a third period t3 after the second period t2, the first input signal IN1 having the high level H, the (1-1)-th clock signal CK1-1 having the low level L, and the second write scan signal GW2 having the low level L may be applied to the first stage ST1.

The first and second transistors T1 and T2 may be turned off in response to the first input signal IN1 having the high level H. In response to the (1-1)-th clock signal CK1-1 having the low level L, the third and fifth transistors T3 and T5 may be turned on, and the sixth transistor T6 may be turned off. The first reset transistor RT1 may be turned on in response to the second write scan signal GW2 having the low level L.

The first voltage VGH may be applied to the first node N1 through the turned-on third transistor T3. The first voltage VGH may be applied to the second node N2 through the turned-on first reset transistor RT1. The first voltage VGH may be applied to the fourth node N4 through the turned-on fifth transistor T5. The first voltage VGH may be applied to the fourth node N4, and the fourth node N4 may be initialized.

When the first voltage VGH is applied to the fourth node N4, like the first period t1, the first output buffer OBP1 may output the first write scan signal GW1 having the high level H.

When a display device DD is powered on or reset, a reset signal ESR activated in the low level L may be applied to the first stage ST1. When the reset signal ESR activated in the low level L is applied to the second reset transistor RT2, the same operation may be performed as when the second write scan signal GW2 having the low level L is applied to the first reset transistor RT1.

Referring to FIGS. 8, 9, and 11A to 11C, in an embodiment of the inventive concept, a first clock signal, which is a single clock signal, may be applied to each of the stages ST1 to STn, instead of applying two clock signals with opposite phases to each of the stages ST1 to STn. For example, one clock signal among the (1-1)-th, (1-2)-th, (1-3)-th, and (1-4)-th clock signals CK1-1, CK1-2, CK1-3, and CK1-4 may be applied to each of the stages ST1 to STn. When a single clock signal is applied in each of the stages ST1 to STn instead of two clock signals being used, power consumption may be reduced.

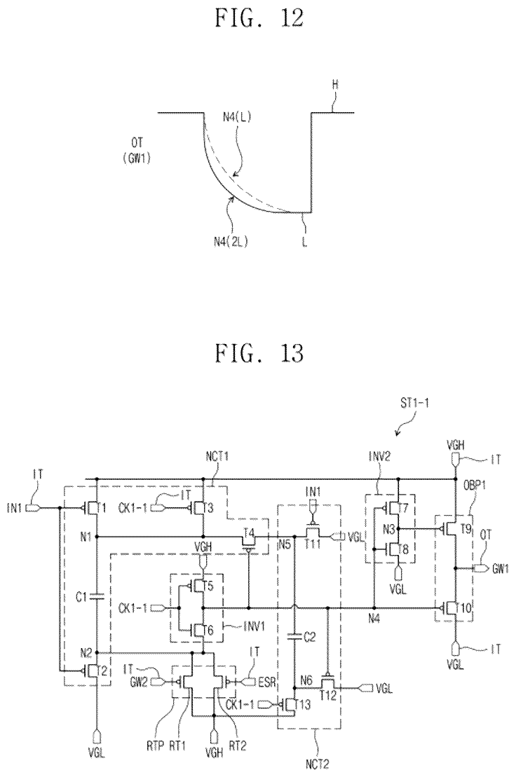

FIG. 12 illustrates a charge state of a first write scan signal which is output through the output terminal illustrated in FIG. 9.

Referring to FIG. 11B and FIG. 12, a voltage with a low level L may be applied to the first output buffer OBP1, and a first write scan signal GW1 having a low level L may be output through the output terminal OT. That is, according to a voltage of a fourth node N4, the first write scan signal GW1 may set to the low level L, which is a target level, and be output through the output terminal OT.

When the fourth node N4 has the low level L, which is a second voltage VGL, the level of the first write scan signal GW1 may be slowly and insufficiently changed to the low level L, as illustrated with a dotted line. However, according to an embodiment of the inventive concept, as the fourth node N4 has a third voltage VL1 having a low level 2L that is lower than the low level L, the level of the first write scan signal GW1 may be rapidly and sufficiently changed to the low level L, as illustrated with a solid line.

In an embodiment of the inventive concept, the first write scan signal GW1 may be rapidly and sufficiently charged to a target level (for example, low level) using the third voltage VL1 of the fourth node N4 which is lower than the second voltage VGL. Accordingly, more write scan signals having a sufficient low level may be provided to pixels PX.

FIG. 13 illustrates a circuit configuration of a first stage of a first scan driver according to an embodiment of the inventive concept.

Hereinafter, components of a first stage ST1-1 illustrated in FIG. 13 will be described focusing on components different from the components illustrated in FIG. 9.

Referring to FIG. 13, the first stage ST1-1 may include a second node controller NCT2. The second node controller NCT2 may be connected to a first node controller NCT1 and a fourth node N4.

The second node controller NCT2 may be connected to a fifth node N5 and a sixth node N6. A second electrode of a fourth transistor T4 may be connected to the fifth node N5. The second node controller NCT2 may be connected to the first node controller NCT1 through the fifth node N5. The second node controller NCT2 may receive a first input signal IN1, a first voltage VGH, a second voltage VGL, and a (1-1)-th clock signal CK1-1.

The second node controller NCT2 may control a voltage level of the fifth node N5 and a voltage level of the sixth node N6 in response to the first input signal IN1, the first voltage VGH, the second voltage VGL, the (1-1)-th clock signal CK1-1, and a voltage of the fourth node N4. The second node controller NCT2 may control the voltage level of the fifth node N5 and the voltage level of the sixth node N6 to have different levels from each other.

The second node controller NCT2 may include an eleventh transistor T11, a twelfth transistor T12, a thirteenth transistor T13, and a second capacitor C2. The eleventh, twelfth, and thirteenth transistors T11, T12, and T13 may include a PMOS transistor.

The eleventh transistor T11 may include a first electrode connected to the fifth node N5, a second electrode receiving the second voltage VGL, and a control electrode receiving the first input signal IN1. The eleventh transistor T11 may be turned on or turned off in response to the first input signal IN1.

The twelfth transistor T12 may include a first electrode connected to the sixth node N6, a second electrode receiving the second voltage VGL, and a control electrode connected to the fourth node N4. The twelfth transistor T12 may be turned on or turned off in response to the voltage of the fourth node N4.

The thirteenth transistor T13 may include a first electrode receiving the first voltage VGH, a second electrode connected to the sixth node N6, and a control electrode receiving the (1-1)-th clock signal CK1-1. The thirteenth transistor T13 may be turned on or turned off in response to the (1-1)-th clock signal CK1-1.

The second capacitor C2 may include a first electrode connected to the fifth node N5 and a second electrode connected to the sixth node N6.

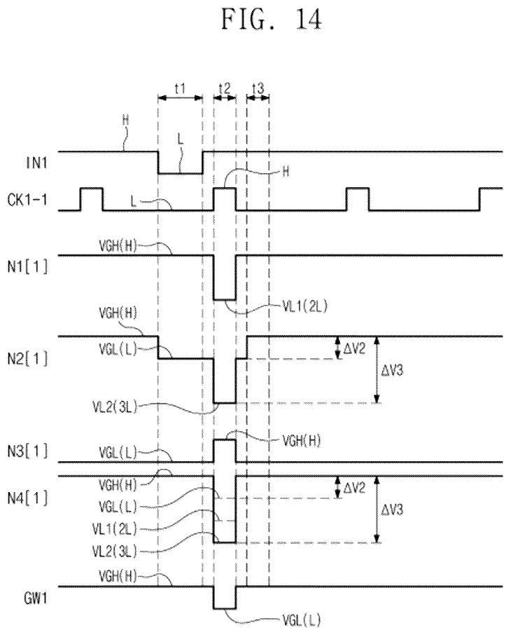

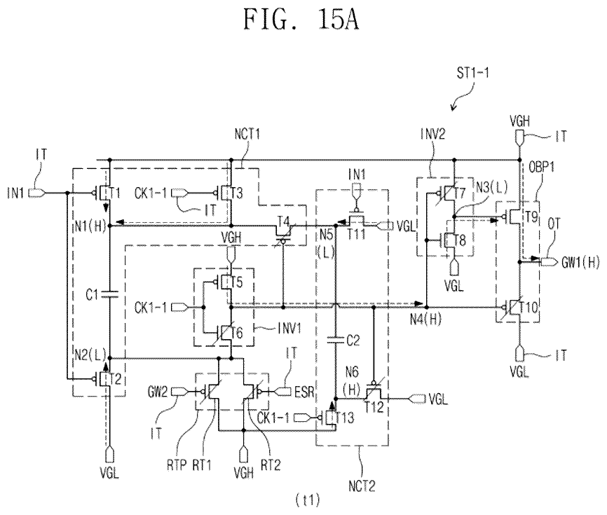

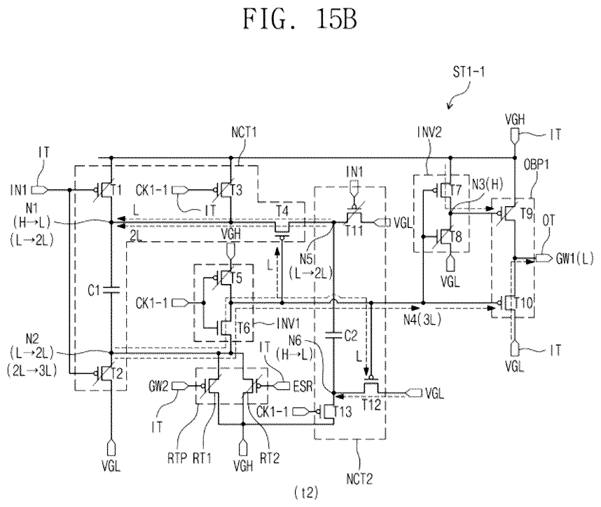

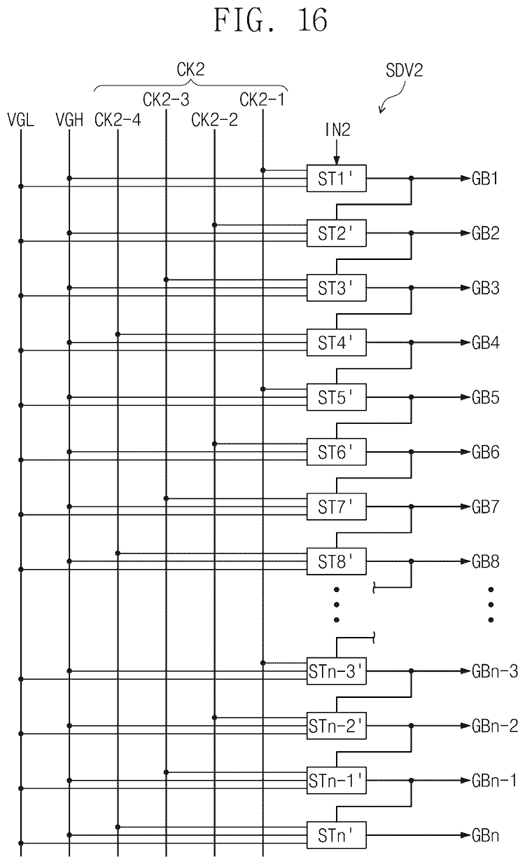

FIG. 14 is a timing diagram of signals applied to a first stage of a first scan driver illustrated in FIG. 13. FIGS. 15A and 15B illustrate operations of a first stage of a first scan driver with respect to a first period and second period illustrated in FIG. 14.

A first period t1, second period t2, and third period t3 illustrated in FIG. 14 may respectively correspond to the first period t1, second period t2, and third period t3 illustrated in FIG. 10A. Hereinafter, an operation of a second node controller NCT2 will be mainly described, and other components will be briefly described.

Referring to FIGS. 14 and 15A, in the first period t1, as illustrated in FIG. 11A, a first node N1 may be set to a first voltage VGH, and a second node N2 may be set to a second voltage VGL.

In the first period t1, a first input signal IN1 having a low level L may be applied to an eleventh transistor T11. In addition, a (1-1)-th clock signal CK1-1 having the low level L may be applied to a thirteenth transistor T13. The eleventh transistor T11 may be turned on in response to the first input signal IN1 having the low level L, and the thirteenth transistor T13 may be turned on in response to the (1-1)-th clock signal CK1-1 having the low level L.

The second voltage VGL (for example, the low level L) may be applied to a fifth node N5 through the turned-on eleventh transistor T11. The first voltage VGH (for example, a high level H) may be applied to a sixth node N6 through the turned-on thirteenth transistor T13. Accordingly, the fifth node N5 may be set to the second voltage VGL, and the sixth node N6 may be set to the first voltage VGH.

A second node controller NCT2 may set a voltage of the fifth node N5 to the second voltage VGL and set a voltage of the sixth node N6 to the first voltage VGH in response to the first input signal IN1 and the (1-1)-th clock signal CK1-1. A charge corresponding to a voltage difference between the first voltage VGH and the second voltage VGL may be stored in a second capacitor C2.

The first voltage VGH of a fourth node N4 may be applied to a twelfth transistor T12. The twelfth transistor T12 may be turned off in response to the first voltage VGH of the fourth node N4.

Referring to FIGS. 14 and 15B, in the second period t2, the second voltage VGL of the second node N2 may be output through a first inverter INV1 and be applied to the fourth and twelfth transistors T4 and T12. The fourth and twelfth transistor T4 and T12 may be turned on in response to the second voltage VGL of the second node N2, which has the low level L.

The second voltage VGL of the fifth node N5 may be provided to the first node N1 through the turned-on fourth transistor T4. Accordingly, as illustrated in FIG. 11B, the first node N1 may be converted from the first voltage VGH having the high level H into the second voltage VGL having the low level L, and the second node N2 may be changed by a first capacitor C1 to a third voltage VL1 having a low level 2L.

The second voltage VGL may be applied to the sixth node N6 through the turned-on twelfth transistor T12. Accordingly, the voltage of the sixth node N6 may be converted from the first voltage VGH having the high level H to the second voltage VGL having the low level L.

When the sixth node N6 is converted from the high level H to the low level L, by a coupling operation of the second capacitor C2, the voltage of the fifth node N5 may be converted from the second voltage VGL to the third voltage VL1 (for example, the low level 2L). The voltage of the fifth node N5 may be changed from the second voltage VGL to the third voltage VL1 by the second capacitor C2.

The third voltage VL1 of the fifth node N5 may be applied to the first node N1. Accordingly, the voltage of the first node N1 may be converted from the second voltage VGL to the third voltage VL1 having the low level 2L.

When the voltage of the first node N1 is converted from the low level L to the low level 2L, by a coupling operation of the first capacitor C1, the voltage of the second node N2 may be converted from the third voltage VL1 to a fourth voltage VL2. The fourth voltage VL2 may have a low level 3L. Accordingly, the first node N1 may be set to the third voltage VL1, and the second node N2 may be set to the fourth voltage VL2.

Through the above operation, when the second node controller NCT2 provides the third voltage VL1 to the first node N1, the first node controller NCT1 may set the voltage of the first node N1 to the third voltage VL1, and set the voltage of the second node N2 to the fourth voltage VL2.

A voltage difference AV3 between the first voltage VGH and the fourth voltage VL2 may be three times a voltage difference AV2 between the first voltage VGH and the second voltage VGL.

The fourth voltage VL2 of the second node N2 may be provided to the fourth node N4 through the first inverter INV1. Since the fourth node N4 has the low level 3L, a first write scan signal GW1 may be more rapidly charged to the low level L and be output through the output terminal OT.

Since an operation of the first stage ST1-1 in the third period t3 is the same as the operation of the first stage ST1 in the third period t3 described with reference to FIG. 11C, the description thereof is omitted.

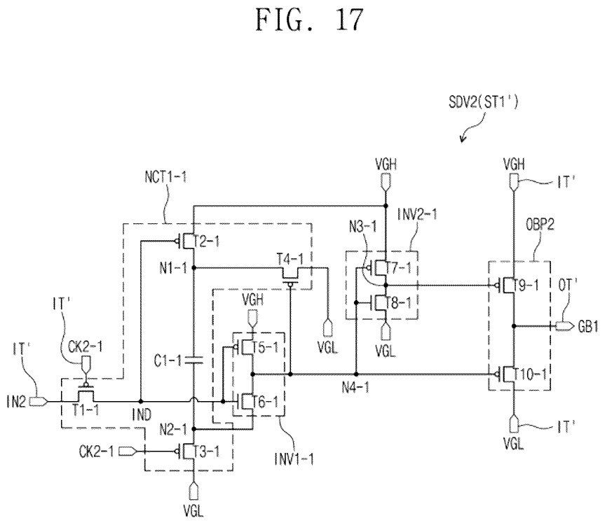

FIG. 16 is a block diagram of a second scan driver included in the scan driver illustrated in FIG. 5.

Referring to FIG. 16, a scan driver SDV may include a second scan driver SDV2. The second scan driver SDV2 may include a plurality of stages ST1′ to STn′ connected sequentially and successively. The stages ST1′ to STn′ may include first to n-th stages ST1′ to STn′.

The stages ST1′ to STn′ may generate and output bias scan signals GB1 to GBn. The bias scan signals GB1 to GBn may be output through the bias scan lines GBL1 to GBLn illustrated in FIG. 5 and provided to pixels PX.

The stages ST1′ to STn′ may receive a second input signal IN2, a plurality of second clock signals CK2, a first voltage VGH, and a second voltage VGL. The aforementioned scan control signal SCS may include the second input signal IN2 and the second clock signals CK2.

The second clock signals CK2 may include a (2-1)-th clock signal CK2-1, a (2-2)-th clock signal CK2-2, a (2-3)-th clock signal CK2-3, and a (2-4)-th clock signal CK2-4. The (2-1)-th clock signal CK2-1, the (2-2)-th clock signal CK2-2, the (2-3)-th clock signal CK2-3, and the (2-4)-th clock signal CK2-4 may be sequentially shifted clock signals.

The (2-1)-th clock signal CK2-1 may be applied to (4 h-3)-th stages. The (2-2)-th clock signal CK2-2 may be applied to (4 h-2)-th stages. The (2-3)-th clock signal CK2-3 may be applied to (4 h-1)-th stages. The (2-4)-th clock signal CK2-4 may be applied to 4 h-th stages.

The second input signal IN2 may be applied to the first stage ST1′. A (h+1)-th stage may receive a bias scan signal output from a h-th stage. The bias scan signal output from the h-th stage and provided to the (h+1)-th stage may be referred to as a second input signal, like the second input signal IN2.

The first stage ST1′ may be activated by the second input signal IN2. The (h+1)-th stage may be activated by receiving the bias scan signal output from the h-th stage.

The activated stages ST1′ to STn′ may generate the bias scan signals GB1 to GBn by using the second clock signals CK2-1 to CK2-4, the first voltage VGH, and the second voltage VGL. The bias scan signals GB1 to GBn may be applied to the pixels PX. For example, the bias scan signals GB1 to GBn output from the stages ST1′ to STn′ of the second scan driver SDV2 may be referred to as second scan signals.

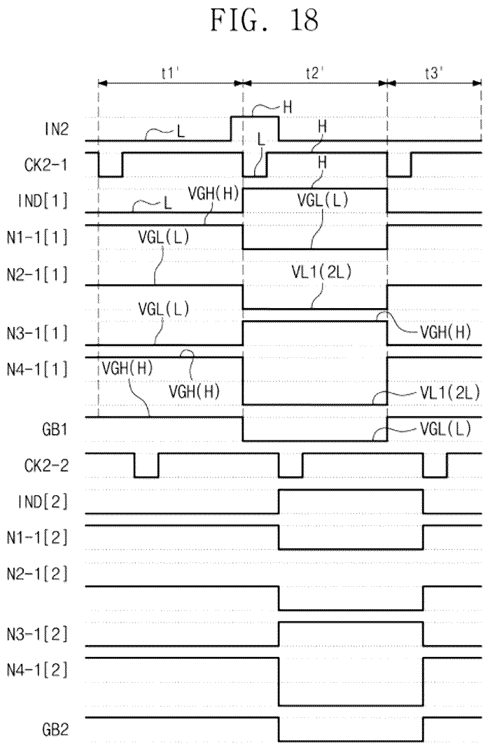

FIG. 17 illustrates a circuit configuration of the first stage of the second scan driver illustrated in FIG. 16.

Although not illustrated, the second to n-th stages ST2′ to STn′ may have the same circuit configuration as the first stage ST1′.

Referring to FIG. 17, the first stage ST1′ may receive a second input signal IN2, a (2-1)-th clock signal CK2-1, a first voltage VGH, and a second voltage VGL through input terminals IT′. The first stage ST1′ may output a first bias scan signal GB1 through an output terminal OT′.

The first stage ST1′ may include a (1-1)-th node controller NCT1-1, a (1-1)-th inverter INV1-1, a (2-1)-th inverter INV2-1, and a second output buffer OBP2.

The (1-1)-th inverter INV1-1 may receive the first voltage VGH, and may be connected to an input node IND, a (2-1)-th node N2-1, and a (4-1)-th node N4-1. The (1-1)-th inverter INV1-1 may be connected to the (1-1)-th node controller NCT1-1 through the input node IND and the (2-1)-th node N2-1. The (1-1)-th inverter INV1-1 may invert the second input signal IN2 that is provided through the input node IND and output the inverted second input signal IN2.

The (2-1)-th node N2-1 may be connected to the (4-1)-th node N4-1 through the (1-1)-th inverter INV1-1. Accordingly, similar to the first stage ST1 of the first scan driver SDV1, a voltage of the (2-1)-th node N2-1 may be provided to the (4-1)-th node N4-1 through the (1-1)-th inverter INV1-1.

The (1-1)-th node controller NCT1-1 may be connected to the input node IND, a (1-1)-th node N1-1, and the (2-1)-th node N2-1. The (1-1)-th node controller NCT1-1 may receive the second input signal IN2, the first voltage VGH, the second voltage VGL, and the (2-1)-th clock signal CK2-1. The (1-1)-th node controller NCT1-1 may provide the second input signal IN2 to the input node IND in response to the (2-1)-th clock signal CK2-1.

The (1-1)-th node controller NCT1-1 may control a voltage level of the (1-1)-th node N1-1 and a voltage level of the (2-1)-th node N2-1 to have different levels from each other in response to the second input signal IN2, the first voltage VGH, the second voltage VGL, the (2-1)-th clock signal CK2-1, and an output signal of the (1-1)-th inverter INV1-1.

The second output buffer OBP2 may be connected to a (3-1)-th node N3-1 and the (4-1)-th node N4-1, and may receive the first voltage VGH and the second voltage VGL. The second output buffer OBP2 may output the first bias scan signal GB1 in response to voltage levels of the (3-1)-th and (4-1)-th nodes N3-1 and N4-1.

The (2-1)-th inverter INV2-1 may be connected to the (3-1)-th and (4-1)-th nodes N3-1 and N4-1, and may receive the first voltage VGH. The (2-1)-th inverter INV2-1 may invert the voltage level of the (4-1)-th node N4-1 and provide the inverted voltage level to the (3-1)-th node N3-1.

The (1-1)-th node controller NCT1-1 may include a (1-1)-th transistor T1-1, a (2-1)-th transistor T2-1, a (3-1)-th transistor T3-1, a (4-1)-th transistor T4-1, and a (1-1)-th capacitor C1-1. The (1-1)-th, (2-1)-th, (3-1)-th, and (4-1)-th transistors T1-1, T2-1, T3-1, and T4-1 may include a PMOS transistor.

The (1-1)-th transistor T1-1 may include a first electrode receiving the second input signal IN2, a second electrode connected to the input node IND, and a control electrode receiving the (2-1)-th clock signal CK2-1. The (2-1)-th transistor T2-1 may include a first electrode receiving the first voltage VGH, a second electrode connected to the (1-1)-th node N1-1, and a control electrode connected to the input node IND.

The (3-1)-th transistor T3-1 may include a first electrode connected to the (2-1)-th node N2-1, a second electrode receiving the second voltage VGL, and a control electrode receiving the (2-1)-th clock signal CK2-1. The (4-1)-th transistor T4-1 may include a first electrode connected to the (1-1)-th node N1-1, a second electrode receiving the second voltage VGL, and a control electrode connected to the (4-1)-th node N4-1. The (1-1)-th capacitor C1-1 may include a first electrode connected to the (1-1)-th node N1-1 and a second electrode connected to the (2-1)-th node N2-1.

The (1-1)-th inverter INV1-1 may include a (5-1)-th transistor T5-1 that is a PMOS transistor and a (6-1)-th transistor T6-1 that is an NMOS transistor. The (5-1)-th transistor T5-1 may include a first electrode receiving the first voltage VGH, a second electrode connected to the (4-1)-th node N4-1, and a control electrode connected to the input node IND. The (6-1)-th transistor T6-1 may include a first electrode connected to the (2-1)-th node N2-1, a second electrode connected to the (4-1)-th node N4-1, and a control electrode connected to the input node IND.

The (2-1)-th inverter INV2-1 may include a (7-1)-th transistor T7-1 and an (8-1)-th transistor T8-1. The second output buffer OBP2 may include a (9-1)-th transistor T9-1 and a (10-1)-th transistor T10-1.

Since configurations of the (2-1)-th inverter INV2-1 and the second output buffer OBP2 of the first stage ST1′ of the second scan driver SDV2 are substantially the same as those of the aforementioned second inverter INV2 and the first output buffer OBP1 of the first stage ST1 of the first scan driver SDV1 illustrated in FIG. 9, description of configurations of the transistors in the (2-1)-th inverter INV2-1 and the second output buffer OBP2 is omitted.

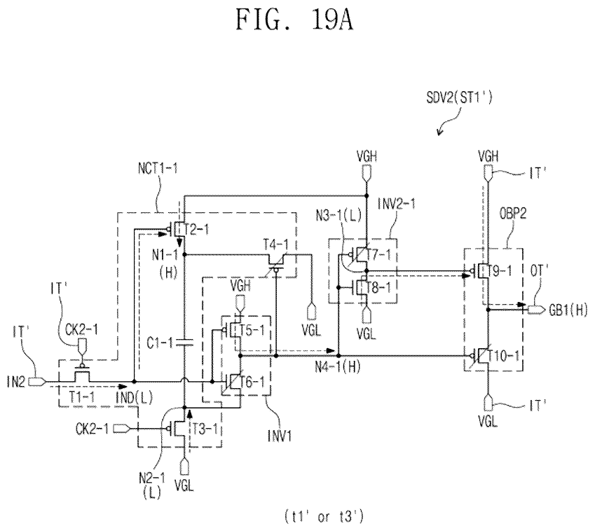

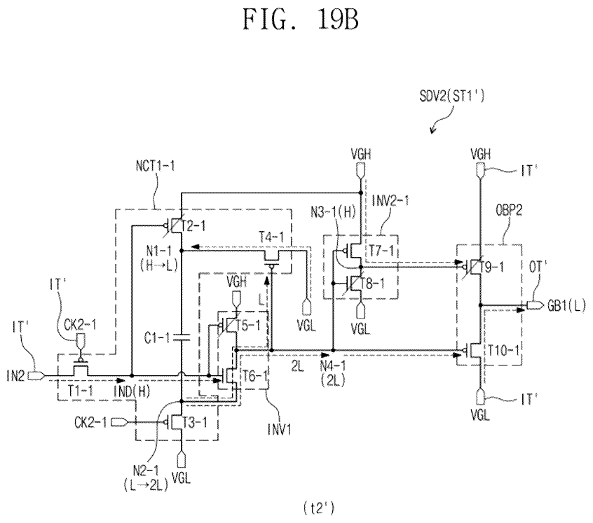

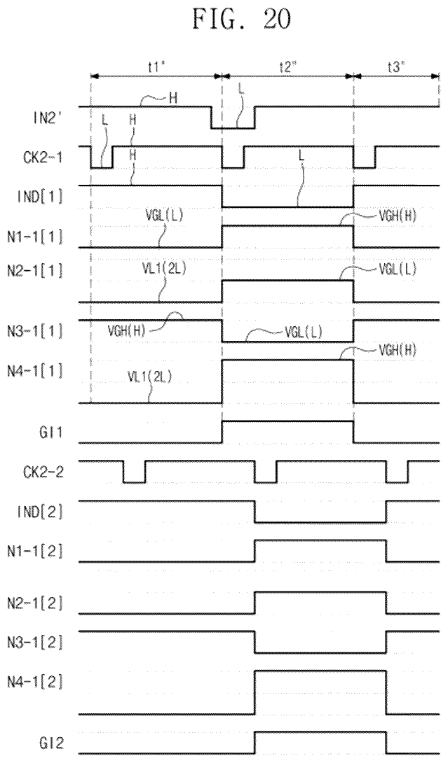

FIG. 18 is a timing diagram of signals applied to the first and second stages of the second scan driver illustrated in FIG. 16. FIGS. 19A and 19B illustrate operations of a first stage of a second scan driver with respect to a first period and second period illustrated in FIG. 18.

Referring to FIG. 18, a (2-2)-th clock signal CK2-2 may be a shifted signal of a (2-1)-th clock signal CK2-1. Although not illustrated, similar to the aforementioned (1-3)-th and (1-4)-th clock signals CK1-3 and CK1-4, a (2-3)-th clock signal CK2-3 may be a shifted signal of the (2-2)-th clock signal CK2-2, and a (2-4)-th clock signal CK2-4 may be a shifted signal of the (2-3)-th clock signal CK2-3.

A second clock signal CK2 may be a signal having an opposite phase to a first clock signal CK1. For example, the (2-1)-th clock signal CK2-1 may be a phase-inverted signal of the (1-1)-th clock signal CK1-1 illustrated in FIG. 10A. In addition, the (2-2)-th clock signal CK2-2 may be a phase-inverted signal of the (1-2)-th clock signal CK1-2 illustrated in FIG. 10A.

Although not illustrated, the (2-3)-th clock signal CK2-3 may be a phase-inverted signal of the (1-3)-th clock signal CK1-3 illustrated in FIG. 10B, and the (2-4)-th clock signal CK2-4 may be a phase-inverted signal of the (1-4)-th clock signal CK1-4 illustrated in FIG. 10B.

A first period t1′, a second period t2′, and a third period t3′ which are successive may be defined. Each of the first period t1′, the second period t2′, and the third period t3′ may be defined as one cycle of the (2-1)-th clock signal CK2-1, which changes from a low level L to a high level H.

Referring to FIGS. 18 and 19A, in the first period t1′, when the (2-1)-th clock signal CK2-1 has the low level L, a (1-1)-th transistor T1-1 may be turned on. A second input signal IN2 having the low level L may be provided to an input node IND through the turned-on (1-1)-th transistor T1-1.

A signal of the input node IND having the low level L may be applied to a (2-1)-th transistor T2-1, and the (2-1)-th transistor T2-1 may be turned on. A first voltage VGH may be applied to a (1-1)-th node N1-1 through the turned-on (2-1)-th transistor T2-1. When the (2-1)-th clock signal CK2-1 has the low level L, a (3-1)-th transistor T3-1 may be turned on. A second voltage VGL may be applied to a (2-1)-th node N2-1 through the turned-on (3-1)-th transistor T3-1.

Accordingly, in the first period t1′, a (1-1)-th node controller NCT1-1 may set the voltage of the (1-1)-th node N1-1 to the first voltage VGH, and set the voltage of the (2-1)-th node N2-1 to the second voltage VGL.

The signal of the input node IND having the low level L may be applied to (5-1)-th and (6-1)-th transistors T5-1 and T6-1, so that the (5-1)-th transistor T5-1 may be turned on and the (6-1)-th transistor T6-1 may be turned off. Accordingly, the first voltage VGH may be applied to a (4-1)-th node N4-1.

Similar to the operation described with reference to FIG. 11A, when the (4-1)-th node N4-1 is set to the first voltage VGH, a first bias scan signal GB1 having the high level H may be output though an output terminal OT′.

Referring to FIGS. 18 and 19B, in the second period t2′, when the (2-1)-th clock signal CK2-1 has the low level L, the second input signal IN2 may have the high level H. The (1-1)-th transistor T1-1 may be turned on, and the second input signal IN2 having the high level H may be provided to the input node IND through the turned-on (1-1)-th transistor T1-1.

A signal of the input node IND having the high level H may be applied to the (5-1)-th and (6-1)-th transistors T5-1 and T6-1, so that the (5-1)-th transistor T5-1 may be turned off and the (6-1)-th transistor T6-1 may be turned on. Accordingly, the second voltage VGL of the (2-1)-th node N2-1 may be applied to the (4-1)-th transistor T4-1.

The (4-1)-th transistor T4-1 may be turned on in response to the second voltage VGL of the (2-1)-th node N2-1 which has the low level L. The second voltage VGL may be applied to the (1-1)-th node N1-1 through the turned-on (4-1)-th transistor T4-1. Accordingly, similar to the operation described with reference to FIG. 11B, the voltage of the (1-1)-th node N1-1 may be converted from the first voltage VGH to the second voltage VGL, and the voltage of the (2-1)-th node N2-1 may be converted from the second voltage VGL to a third voltage VL1. Therefore, the voltage of the (1-1)-th node N1-1 may have the low level L, and the voltage of the (2-1)-th node N2-1 may have a low level 2L.

The third voltage VL1 of the (2-1)-th node N2-1 may be provided to the (4-1)-th node N4-1 through a (1-1)-th inverter INV1-1. Accordingly, similar to the operation described with reference to FIG. 11B, the first bias scan signal GB1 having the low level L may be output through the output terminal OT′.

A signal level of the first bias scan signal output from the output terminal OT′ may be rapidly charged to a target level (for example, the low level L) by the third voltage VL1 of the (2-1)-th node N2-1 which has the low level 2L. Therefore, more bias scan signals having a sufficient low level may be provided to pixels PX.

The operation of the first stage ST1′ during the third period t3′ may be substantially the same as the operation of the first stage ST1′ during the first period t1′.

Although not illustrated, the scan driver SDV may include a third scan driver which generates initialization scan signals and a fourth scan driver which generates compensation scan signals.

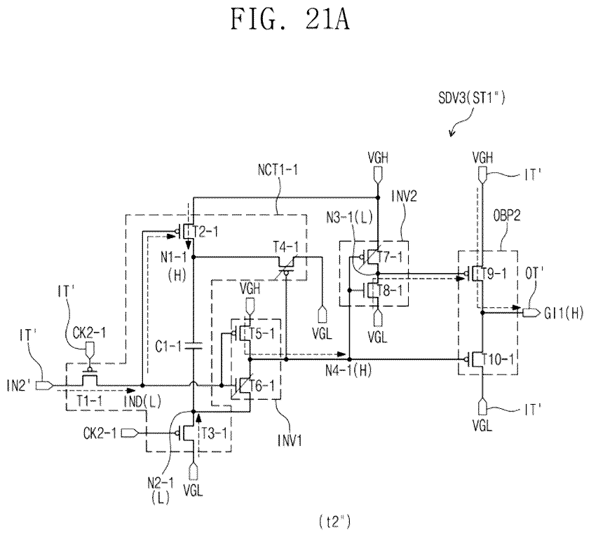

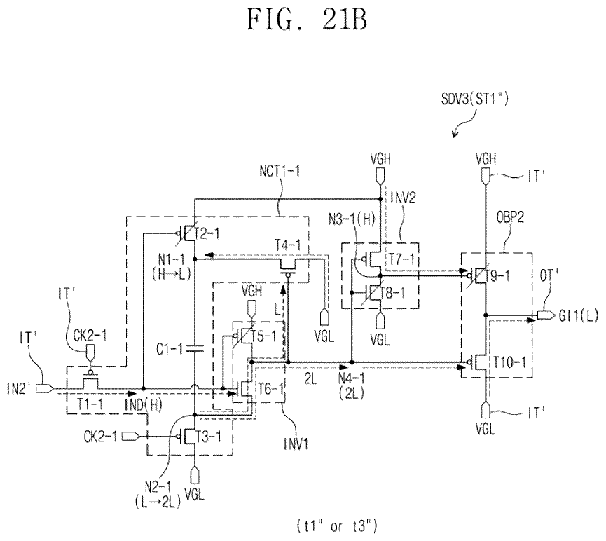

FIG. 20 is a timing diagram of signals applied to first and second stages of a third scan driver. FIG. 21A illustrates an operation of the first stage of the third scan driver with respect to a second period illustrated in FIG. 20. FIG. 21B illustrates an operation of the first stage of the third scan driver with respect to a first period illustrated in FIG. 20.

Referring to FIG. 20, a second input signal IN2′ provided to the third scan driver may have an inverted level of the second input signal IN2 provided to the second scan driver SDV2. Timing of other signals may be substantially the same as the timing illustrated in FIG. 18.

In the second period t2′ illustrated in FIG. 18, when the (2-1)-th clock signal CK2-1 has the low level L, the second input signal IN2 may have the high level H. However, in a second period t2″ illustrated in FIG. 20, when a (2-1)-th clock signal CK2-1 has a low level L, the second input signal IN2′ may have the low level L.

Referring to FIGS. 21A and 21B, a circuit configuration of a first stage ST1″ of a third scan driver SDV3 may be substantially the same as the circuit configuration of the first stage ST1′ of the second scan driver SDV2 illustrated in FIG. 17.

Referring to FIGS. 20 and 21A, in the second period t2″, when the (2-1)-th clock signal CK2-1 has the low level L, the second input signal IN2′ may have the low level L. Accordingly, an operation of the first stage ST1″ of the third scan driver SDV3 may be substantially the same as the operation of the first stage ST1′ of the second scan driver SDV2 during the aforementioned first period t1′.

Referring to FIGS. 20 and 21B, in a first period t1 “, when the (2-1)-th clock signal CK2-1 has the low level L, the second input signal IN2′ may have the high level H. Accordingly, an operation of the first stage ST1” of the third scan driver SDV3 may be substantially the same as the operation of the first stage ST1′ of the second scan driver SDV2 during the aforementioned second period t2′.

Referring to FIGS. 20, 21A, and 21B, the first stage ST1″ of the third scan driver SDV3 may output a first initialization scan signal GI1, which has the high level H, during the second period t2″.

Although not illustrated, a fourth scan driver may also have substantially the same circuit configuration as the second scan driver SDV2. In addition, operation timing of the fourth scan driver may be substantially similar to the timing illustrated in FIG. 20. The fourth scan driver may also output compensation scan signals having the high level H by operating similarly to the first stage ST1″ of the third scan driver SDV3, except that high-level output timing of each of the compensation scan signals is different from high-level output timing of each of initialization scan signals.

Although not illustrated, the aforementioned emission driver EDV may also have substantially the same circuit configuration as the second scan driver SDV2. In addition, operation timing of the emission driver EDV may be substantially similar to the timing illustrated in FIG. 20. Accordingly, the emission driver EDV may also output emission signals having the high level H by operating similarly to the first stage ST1″ of the third scan driver SDV3.

According to an embodiment of the inventive concept, since scan signals are generated by using a single clock signal instead of using two clock signals that have opposite phases to each other, power consumption may be reduced.

In addition, the scan signals may be rapidly charged to a target level (for example, low level) by a third voltage having a lower level than a second voltage, thereby providing more normal scan signals to pixels.

In the above, description has been made with reference to embodiments of the inventive concept, but those skilled in the art may appreciate that various modifications and changes may be made to the inventive concept insofar as such modifications and changes do not depart from the spirit and technical scope of the inventive concept set forth in the claims to be described later.

Therefore, the technical scope of the inventive concept is not to be limited to the contents stated in the detailed description of the specification, but should be determined by the claims.

1. A display device comprising:
a pixel; and
a first scan driver configured to provide a first scan signal to the pixel,
wherein the first scan driver includes:
a first inverter configured to invert a first clock signal and output an inverted first clock signal;
a first node controller configured to control voltage levels of a first node and a second node to have different levels from each other in response to a first input signal and an output signal of the first inverter;
a first output buffer configured to output the first scan signal in response to voltage levels of a third node and a fourth node; and
a second inverter configured to invert the voltage level of the fourth node and provide an inverted voltage level of the fourth node to the third node, and
wherein the second node is connected to the fourth node through the first inverter.

2. The display device of claim 1, wherein the first inverter receives a first voltage, and provides the first voltage or a voltage of the second node to the first node controller and the fourth node in response to the first clock signal.

3. The display device of claim 2, wherein the first node controller receives the first voltage and a second voltage which has a lower level than the first voltage, and
the first node controller sets a voltage of the first node to the first voltage or the second voltage, and sets a voltage of the second node to the second voltage or a third voltage which has a lower level than the second voltage in response to the first input signal and the output signal of the first inverter.

4. The display device of claim 3, wherein, when the first inverter outputs the first voltage in response to the first clock signal, the first node controller sets the voltage of the first node to the first voltage and the voltage of the second node to the second voltage in response to the first input signal.

5. The display device of claim 4, wherein the first inverter provides the first voltage to the fourth node.

6. The display device of claim 3, wherein, when the first inverter outputs the second voltage of the second node in response to the first clock signal, the first node controller sets the voltage of the first node to the second voltage and the voltage of the second node to the third voltage in response to the output signal of the first inverter.

7. The display device of claim 6, wherein the third voltage of the second node is provided to the fourth node through the first inverter.

8. The display device of claim 3, wherein a voltage difference between the first voltage and the third voltage is twice a voltage difference between the first voltage and the second voltage.

9. The display device of claim 3, further comprising a second node controller connected to the first node controller and the fourth node,
wherein, when the first inverter outputs the second voltage of the second node in response to the first clock signal, the second node controller provides the third voltage to the first node, and
the first node controller sets the voltage of the first node to the third voltage and sets the voltage of the second node to a fourth voltage which has a lower level than the third voltage.

10. The display device of claim 9, wherein a voltage difference between the first voltage and the fourth voltage is three times a voltage difference between the first voltage and the second voltage.

11. The display device of claim 1, wherein the first node controller comprises:
a first transistor which includes a first electrode configured to receive a first voltage, a second electrode connected to the first node, and a control electrode configured to receive the first input signal;
a second transistor which includes a first electrode connected to the second node, a second electrode configured to receive a second voltage that has a lower level than the first voltage, and a control electrode configured to receive the first input signal;
a third transistor which includes a first electrode configured to receive the first voltage, a second electrode connected to the first node, and a control electrode configured to receive the first clock signal;
a fourth transistor which includes a first electrode connected to the first node, a second electrode configured to receive the second voltage, and a control electrode connected to the fourth node; and
a first capacitor which includes a first electrode connected to the first node, and a second electrode connected to the second node.

12. The display device of claim 11, wherein the first inverter comprises:
a fifth transistor which includes a first electrode configured to receive the first voltage, a second electrode connected to the fourth node, and a control electrode configured to receive the first clock signal; and
a sixth transistor which includes a first electrode connected to the second node, a second electrode connected to the fourth node, and a control electrode configured to receive the first clock signal.

13. The display device of claim 12, wherein the second inverter comprises:
a seventh transistor which includes a first electrode configured to receive the first voltage, a second electrode connected to the third node, and a control electrode connected to the fourth node; and
an eighth transistor which includes a first electrode configured to receive the second voltage, a second electrode connected to the third node, and a control electrode connected to the fourth node, and
wherein the fifth and seventh transistors include a PMOS transistor, and the sixth and eighth transistors include an NMOS transistor.

14. The display device of claim 13, wherein the first output buffer comprises:
a ninth transistor which includes a first electrode configured to receive the first voltage, a second electrode connected to an output terminal that outputs the first scan signal, and a control electrode connected to the third node; and
a tenth transistor which includes a first electrode connected to the output terminal, a second electrode configured to receive the second voltage, and a control electrode connected to the fourth node.

15. The display device of claim 13, further comprising a reset part connected to the second node,
wherein the reset part includes:
a first reset transistor which has a first electrode connected to the second node, a second electrode configured to receive the first voltage, and a control electrode configured to receive a first reset signal, the first reset signal being a shifted signal of the first scan signal; and
a second reset transistor which has a first electrode connected to the second node, a second electrode configured to receive the first voltage, and a control electrode configured to receive a second reset signal.

16. The display device of claim 13, further comprising a second node controller connected to the first node controller and the fourth node,
wherein the second node controller includes:
an eleventh transistor which has a first electrode connected to a fifth node, a second electrode configured to receive the second voltage, and a control electrode configured to receive the first input signal;
a twelfth transistor which has a first electrode connected to a sixth node, a second electrode configured to receive the second voltage, and a control electrode connected to the fourth node;
a thirteenth transistor which has a first electrode configured to receive the first voltage, a second electrode connected to the sixth node, and a control electrode configured to receive the first clock signal; and
a second capacitor which has a first electrode connected to the fifth node, and a second electrode connected to the sixth node.

17. The display device of claim 1, further comprising a second scan driver configured to provide a second scan signal to the pixel,
wherein the second scan driver includes:
a (1-1)-th inverter configured to invert a signal applied to an input node and output the inverted signal;
a (1-1)-th node controller configured to control voltage levels of a (1-1)-th node and a (2-1)-th node to have different levels from each other in response to a second input signal, a second clock signal that has an opposite phase to the first clock signal, and an output signal of the (1-1)-th inverter;
a second output buffer configured to output the second scan signal in response to voltage levels of a (3-1)-th node and a (4-1)-th node; and
a (2-1)-th inverter configured to invert the voltage level of the (4-1)-th node and provide an inverted voltage level of the (4-1)-th node to the (3-1)-th node, and
wherein the (1-1)-th node controller provides the second input signal to the input node in response to the second clock signal, and the (2-1)-th node is connected to the (4-1)-th node through the (1-1)-th inverter.

18. The display device of claim 17, further comprising a third scan driver configured to provide a third scan signal to the pixel,
wherein the third scan driver has a same circuit configuration as the second scan driver, and a second input signal provided to the third scan driver has an inverted level of the second input signal provided to the second scan driver.

19. The display device of claim 17, wherein the (1-1)-th node controller comprises:
a (1-1)-th transistor which includes a first electrode configured to receive the second input signal, a second electrode connected to the input node, and a control electrode configured to receive the second clock signal;
a (2-1)-th transistor which includes a first electrode configured to receive a first voltage, a second electrode connected to the (1-1)-th node, and a control electrode connected to the input node;
a (3-1)-th transistor which includes a first electrode connected to the (2-1)-th node, a second electrode configured to receive a second voltage that has a lower level than the first voltage, and a control electrode configured to receive the second clock signal;
a (4-1)-th transistor which includes a first electrode connected to the (1-1)-th node, a second electrode configured to receive the second voltage, and a control electrode connected to the (4-1)-th node; and
a (1-1)-th capacitor which includes a first electrode connected to the (1-1)-th node and a second electrode connected to the (2-1)-th node,
wherein the (1-1)-th inverter comprises:
a (5-1)-th transistor which includes a first electrode configured to receive the first voltage, a second electrode connected to the (4-1)-th node, and a control electrode connected to the input node; and
a (6-1)-th transistor which includes a first electrode connected to the (2-1)-th node, a second electrode connected to the (4-1)-th node, and a control electrode connected to the input node, and
wherein the (5-1)-th transistor includes a PMOS transistor, and the (6-1)-th transistor includes an NMOS transistor.

20. An electronic apparatus comprising:
a display module configured to display an image based on data received from a processor; and
the processor electrically connected to the display module, and configured to control an operation of the display module,
wherein the display module includes:
a pixel; and
a first scan driver configured to provide a first scan signal to the pixel,
wherein the first scan driver includes:
a first inverter configured to invert a first clock signal and output an inverted first clock signal;
a first node controller configured to control voltage levels of a first node and a second node to have different levels from each other in response to a first input signal and an output signal of the first inverter;
a first output buffer configured to output the first scan signal in response to voltage levels of a third node and a fourth node; and
a second inverter configured to invert the voltage level of the fourth node and provide an inverted voltage level of the fourth node to the third node, and
wherein the second node is connected to the fourth node through the first inverter.
